(19) United States
(12) Patent Application Publication
(10) Pub. No.: US 2008/0153567 A1
(43) Pub. Date: Jun. 26, 2008

(54) Vending machine having a game of chance

(76) Inventors: Scott Juds, Seattle, WA (US); James H. Halsey, El Dorado, AR (US)

Correspondence Address: DILLER, RAMIK & WIGHT, 7345 MCWHORTER PLACE, SUITE 101, ANNANDALE, VA, 22003, US

(21) Appl. No.: 12/073,479

(22) Filed: Mar. 6, 2008

Related U.S. Application Data
(62) Division of application No. 11/190,938, filed on Jul. 28, 2005.
Application No. 11/190,938 is a division of application No. 11/190,935, filed on Jul. 28, 2005.

(51) Int. Cl. A63F 13/00

(52) U.S. Cl. 463/16

(57) ABSTRACT

A machine for vending snacks, product samples, customer appreciation prizes, or time-metered services which offers a patron a game of chance. A patron receives a free fractional vend with a previously purchased product for use in a vending machine having products produced by the same manufacturer, wherein the token activates a game of chance used to determine the value of the token toward the purchase of one of the products. Alternatively, a patron receives a free token within, as part of, or attached to the package of a manufacturer's product to activate a game of chance in a sample vending machine sponsored by the product's manufacturer to determine which free product sample, or other higher value prize, the patron may vend from the machine. As another alternative, a patron uses a purchase receipt having barcoded information summarizing the transaction at a customer appreciation vending machine to activate a game of chance to determine which of a plurality of prizes a patron may vend from the machine. Finally, a patron uses a promotional token to activate a game of chance in a time-metered service vending machine to determine an amount of bonus service time to grant to the patron.

### CROSS REFERENCE TO RELATED APPLICATION

This application is a divisional application of Ser. No. 11/190,935 filed on Jul. 28, 2005 and entitled VENDING MACHINE HAVING A GAME OF CHANCE and now patent Ser. No. ______.

### FIELD OF THE INVENTION

This invention pertains to vending machines, and in particular to vending machines adapted to provide a game of chance to the patron in the process of delivering its vended goods.

### BACKGROUND OF THE INVENTION

Product manufacturers and retailers have always been interested in finding new ways to better attract and hold customers. One method commonly used, particularly by national brands, is to sponsor some form of sweepstakes event to differentiate themselves from a competitor and help build brand awareness. In addition to sweepstakes type attractions, others have tried to integrate gaming concepts into the retail environment to help attract customers.

The psychological attraction to the dream of winning the grand prize in a sweepstakes is not unlike that of winning the state lottery or a jackpot in a slot machine. For some the dream is intoxicatingly attractive, while for others the dream is irrelevant because they assess that the probability of actually winning is so low that it does not warrant the cost in time and effort to participate. To protect those susceptible to the intoxicating dream many state and federal laws have been drafted to regulate sweepstakes, casino gaming, and lotteries. Regulation most often revolves around the combination of the elements of prize, chance, and consideration. To circumvent legal problems, most sweepstakes and other game of chance laws require the sponsor to provide participants with an alternative method of having a chance to win that does not require making a purchase. The most commonly accepted and used practice to achieve this is to provide one “game piece” or one “game entry” to someone who mails a request with a self addressed stamped envelope to the sponsor. Generally, the cost of two envelopes and two postage stamps is higher than the value of the grand prize divided by the number of entries, thus preventing a sweepstakes sponsor from being overwhelmed by such requests and enabling the sweepstakes event to retain commercial value for the sponsor.

Casino type gaming provides a distinctly different psychological attraction from that of a sweepstakes in that it includes the excitement of current play and the anticipation of instant gratification if one wins. Outside of a casino, the most popular form of instant gratification gaming is the scratch ticket. Many state lotteries offer scratch ticket games wherein immediately after purchasing the ticket one scratches the surface paint from game squares on the ticket in an attempt to expose a specific symbol or set of symbols. Scratch tickets have also been occasionally used as a form of instant win sweepstakes by fast-food restaurant chains. Yet another type of psychological attraction in casino gaming is provided by some of the newer slot machines wherein a video reel style slot machine provides so many zigzag win paths across the screen that one pretty much can't help but to win at least something every time the reels spin. Even if you do only get one coin back for having played ten coins, many players are happy because there are not so many disappointing losses in a row.

Some have incorporated a game of chance into the retail environment prior to the check stand. A method of randomly determining the value of a coupon presented to a coupon validator machine by a shopper prior to proceeding to the checkout counter is disclosed in U.S. Pat. No. 5,368,129 granted Nov. 29, 1994 to Van Kohorn. The coupon validator prints the randomized discount amount on the coupon which is returned to the shopper for use at the checkout counter.

Others have incorporated a game of chance at the check stand. A microprocessor based system for connection to a cash register and activated upon each ring-up of a valid sale is disclosed in U.S. Pat. No. 4,854,590 granted Aug. 8, 1989 to Joliff, et al. The system randomly determines if the customer has won anything at all, and if so, what amount has been won. A virtual slot machine display device tied to a point of sale terminal is disclosed in U.S. Pat. No. 6,634,550 granted Oct. 21, 2003 to Walker, et al. The game presentation includes images of products and indicates what has been won, such as a free product, a discount on a product selected for purchase, a coupon, or an upsell offer. A promotional game operating in conjunction with a point of sale terminal displaying the image of a game card is disclosed in U.S. Pat. No. 6,048,268 granted Apr. 11, 2000 to Humble. The game card has areas which appear covered and are exposed by customer selection similar to that of a scratch ticket game. The processor selects prizes and varies the odds of winning a prize as a function of the identity of products purchased by the participant or their dollar value.

Still others have incorporated a game of chance into a vending machine. An instant lottery game for a centrally controlled remote vending machine is disclosed in U.S. Pat. No. 4,157,829 granted Jun. 12, 1979 to Goldman, et al. Upon the receipt of a wager of a proper amount, the central computer generates random indicia to be matched with the patron's pre-selected indicia to determine and pay a cash prize amount. There is no vending of a product, just a lottery game. An automatic vending machine with lottery bonus is disclosed in U.S. Pat. No. 4,213,524 granted Jul. 22, 1980 to Miyashita, et al. A plurality of electric lamps arranged geometrically on a front panel of the machine and a lamp control circuit for lighting the lamps successively and repeatedly in response to a vending signal produces a winning signal for discharging an extra article as a free addition if the light spot is stopped at a predetermined lamp having a lucky number. A vending machine offering a game of chance or skill is disclosed in U.S. Pat. Publication No. 20030186732 filed Oct. 2, 2003 by Viglione. A game is played for a predetermined prize only after payment and selection of a product. A vending machine randomly dispensing prize items, in addition to selected items, is disclosed in U.S. Pat. Publication No. 20020107610 filed Aug. 8, 2002 by Kaehler, et al.

Finally, some have incorporated a game of chance into a promotional machine. A promotional game on an automated redemption machine is disclosed in U.S. Pat. No. 5,007,641 granted Apr. 16, 1991 to Seidman and U.S. Pat. No. 5,080,364 granted Jan. 14, 1992 to Seidman. Prizes are awarded at random to patrons who present appropriate barcoded symbols from coupons or product packages bearing a particular code.

Despite the considerable effort that has been applied heretofore towards improvements in promotional schemes involving a game of chance, many important aspects of such promotions still have not been addressed or stand in need of further improvement. For example, while there have been many prior art promotional schemes to attract people through hopes of winning a grand prize, none have addressed the opposite psychologically minded people who believe their chances of winning the grand prize are so small that it is not worth their time or effort to participate. However, if the game of chance allows everyone to win at least something, and maybe even a grand prize, then most of this same group will conclude that it is worthwhile participating because it is not a total waste of time.

Additionally, although considerable effort has been put forth to add promotional and gaming features to vending machines, as evidenced by the aforementioned prior art patents, there has been little effort spent on algorithms to automatically manage the probability of winning one of a plurality of items having a broad range of values such that the average value of a large population of vended prizes closely approximates a predetermined average value.

Finally, the prior art has not really addressed certain other kinds of vending machines wherein a game of chance promotion may offer a significant benefit. A first example is a product sample vending machine. While there have been specific machine designs for dispensing fluids and sprays in a retail environment, as for example the mannequin shaped perfume sample dispenser disclosed in U.S. Pat. No. 5,535,921 granted Jul. 16, 1996 to Gelman, there has been no prior art vending system for general product samples that a manufacturer can use to attract existing customers of one of its product lines to try a free sample of one of its other product lines to build brand and customer loyalty. A second example is a customer appreciation vending machine. Many of the aforementioned prior art patents disclose methods and systems that burden the retail checkout process in a manner not conducive to improving employee productivity, or require replacement of point of sale equipment that may not be compatible with their back end accounting system and other peripheral equipment. A third example is a time-metered service vending machine such as is common in a self service carwash. Although fixed bonus and token based promotional schemes for time-metered vending machines have existed for quite some time, the excitement of a game of chance has not heretofore been available for them.

As can readily be appreciated, there remains a need for further improvement in the features and operation of vending machines, and in particular vending machines offering a legal game of chance as a promotional feature.

### SUMMARY OF THE INVENTION

In a first embodiment of the present invention a product sample vending machine offers a game of chance to patrons for determining which of a plurality of free product samples and higher valued prize items may be offered to them. The vending machine is enabled by a free token provided to the patron within, as part of, or attached to the package of a manufacturer's product. To help attract patrons to use the machine, higher value prizes, such as a full sized product or an exotic vacation trip may be offered. Whereas the free product samples would be vended directly from the machine, a barcoded ticket is dispensed to the patron as a voucher for the higher value prizes that are not well suited to being directly vended from the machine. The free token may be in the form of a coin-shaped token, a bill shaped token note, an RFID tag from a product package, or a serialized barcode. Limitation of the free token to a single use is provided by non-return of a coin or bill shaped token, or by recording a serial number from an RFID tag or barcode to prevent their future use. The probability of winning each of the items is managed such that the average value of a large population of vended items closely approximates a predetermined average value.

In a second embodiment of the present invention a customer appreciation vending machine offers a game of chance to patrons for determining which of a plurality of consumer items having a broad range of values may be offered to them. The vending machine is enabled by a barcoded purchase receipt the patron receives from a point of sale register at the check stand when purchasing goods and services. The machine may be adapted to always offer the patron at least the lowest valued item held by the machine. Additionally, if a higher value item is offered, the machine may additionally offer the patron a choice of one or more other lower cost items. If the patron has won anything at all, the machine may further offer the patron a bonus game of chance to possibly win an item of higher value. During a bonus game of chance, a patron is shown the probability of winning a higher value item and offered the opportunity to accept or decline play of the bonus game of chance. The probability of winning a particular item is adjusted in proportion to the purchase amount on the barcoded receipt, and inversely in proportion to the value of a particular item. When the purchase receipt has only a purchase ID number embedded within the barcode, then a network connection to a remote database is used to acquire the time, date, and amount of sale information. When one of the smaller valued items has been won and selected by the patron, it is immediately vended to the patron from the machine. A barcoded ticket is dispensed to the patron as a voucher for higher valued items that are not well suited to being directly vended by the machine. The probability of winning each of the items is managed such that the average value of a large population of vended items closely approximates a predetermined average value.

In a third embodiment of the present invention a vending machine for dispensing food or beverage items offers a game of chance to patrons for determining which of a plurality of values a fractional vend token is given for credit toward the purchase of a food or beverage item from the machine. A grand prize token may also be adapted for use with the vending machine. In a first adaptation of the third embodiment, the grand prize token is visually identical to the fractional vend token, but has properties distinguishable by a token validator. The grand prize token is rejected back to the patron by the token validator, but the machine visually indicates to the patron that he has a grand prize token for redemption at a grand prize redemption center. In a second adaptation of the third embodiment, the grand prize token is the same as the fractional vend token and the machine randomly determines if the grand prize has been won. The token remains held by the machine and a barcoded ticket is dispensed to the patron as a voucher for his grand prize to be claimed at a redemption center. The probability of winning each of the items is managed such that the average value of a large population of vended items closely approximates a predetermined average value.

In a fourth embodiment of the present invention a time-metered service vending machine offers a game of chance to patrons for providing additional bonus time to the patron during the vending of selected services. The game of chance may be enabled by either the validation of a promotional token, or by validation of some predetermined threshold amount of payment for the time-metered services. When the game of chance is enabled, the display which is normally adapted to display the amount of received payment and the amount of service time remaining first indicates that a game of chance has been enabled, then displays a rapid sequence of different time values, eventually settling on a bonus time amount to be granted to the patron and added to any other service time for which payment was previously received. The probability of winning any specific amount of bonus time is managed such that the average value of a large population of granted bonus time closely approximates a predetermined average value.

With the above and other objects in view that will hereinafter appear, the nature of the invention will be more clearly understood by reference to the following detailed description, the appended claims and the several views illustrated in the accompanying drawings.

### BRIEF DESCRIPTION OF THE DRAWINGS

FIG. 1a is a top plan view, and illustrates one embodiment of a secured token that is in the shape of a coin having a band of inclined facets that forms a security feature of the token.

FIG. 1b is a top plan view, and illustrates one embodiment of a secured token formed from a barcode on a product's package having an embedded serial number to form a security feature of the token.

FIG. 1c is a top plan view, and illustrates one embodiment of a secured token formed from an RFID tag on a product's package having an antenna and a transponder silicon chip to form a security feature of the token.

FIG. 1d is a top plan view, and illustrates one embodiment of a secured token that is in the shape of paper money having a graphic pattern and paper optical qualities that form a security feature of the token.

FIG. 2a is a top plan view, and illustrates one embodiment of a grocery store receipt having date and price incorporated into the barcode.

FIG. 2b is a top plan view, and illustrates one embodiment of a grocery store receipt having a transaction serial number incorporated into the barcode.

FIG. 3 is a front perspective view, and illustrates a beverage vending machine having a game of chance.

FIG. 4a is front plan view, and illustrates one embodiment of a game of chance controller for a food or beverage vending machine.

FIG. 4b is a side perspective view, and illustrates one embodiment of a game of chance controller for a food or beverage vending machine.

FIG. 5 is a front perspective view, and illustrates a product time-metered vending machine having a game of chance.

FIG. 6 is a front perspective view, and illustrates a product sample vending machine having a game of chance.

FIG. 7 is a front perspective view, and illustrates a customer appreciation vending machine having a game of chance.

FIG. 8 is a front plan view, and illustrates a touch-screen interface for a patron to select one of a plurality of available items.

FIG. 9 is a front plan view, and illustrates a touch-screen interface for a patron to configure and enable a bonus game of chance.

FIG. 10 is a front plan view, and illustrates a visual display of information about a receipt previously used for a game of chance.

FIG. 11 is a block diagram of a vending machine having promotional features, and illustrates components thereof and cooperative interaction therebetween.

FIG. 12 is a block diagram of a vending machine having promotional features, and illustrates components thereof and cooperative interaction therebetween.

FIG. 13 is a table, and shows an example of the win probability of items when the game of chance is enabled with a $30.00 receipt.

FIG. 14 is a table, and shows an example of the win probability of items when the game of chance is enabled with a $3.00 receipt.

FIG. 15 is a graph, and shows the relationship between win probability of an item, the value of the item, and the purchase receipt amount.

FIG. 16 is a table, and shows an example of the win probability of items when the game of chance is enabled with tokens having different values and different product associations.

FIG. 17 is a flow chart, and illustrates performance steps for a game of chance vending machine for product samples.

FIG. 18 is a flow chart, and illustrates performance steps for a game of chance vending machine for customer appreciation prizes.

FIG. 19 is a flow chart, and illustrates performance steps for a game of chance vending machine for customer appreciation prizes.

FIG. 20 is a flow chart, and illustrates performance steps for a game of chance vending machine for food or beverage snack items.

FIG. 21 is a table, and shows an example of the win probability for a fractional vend token.

FIG. 22 is a table, and shows an example of the win probability for a special vend token.

### DETAILED DESCRIPTION OF THE INVENTION

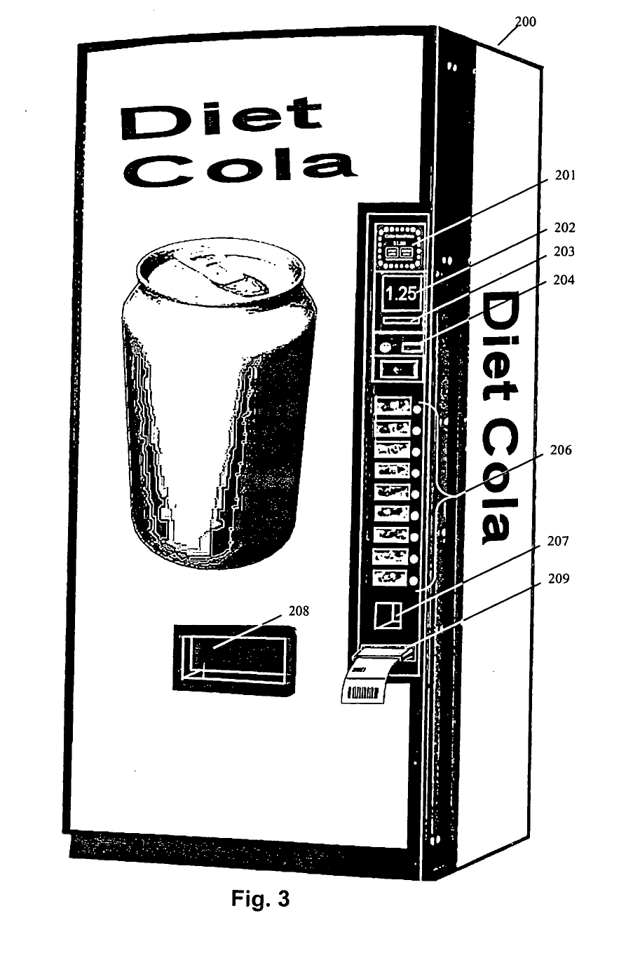

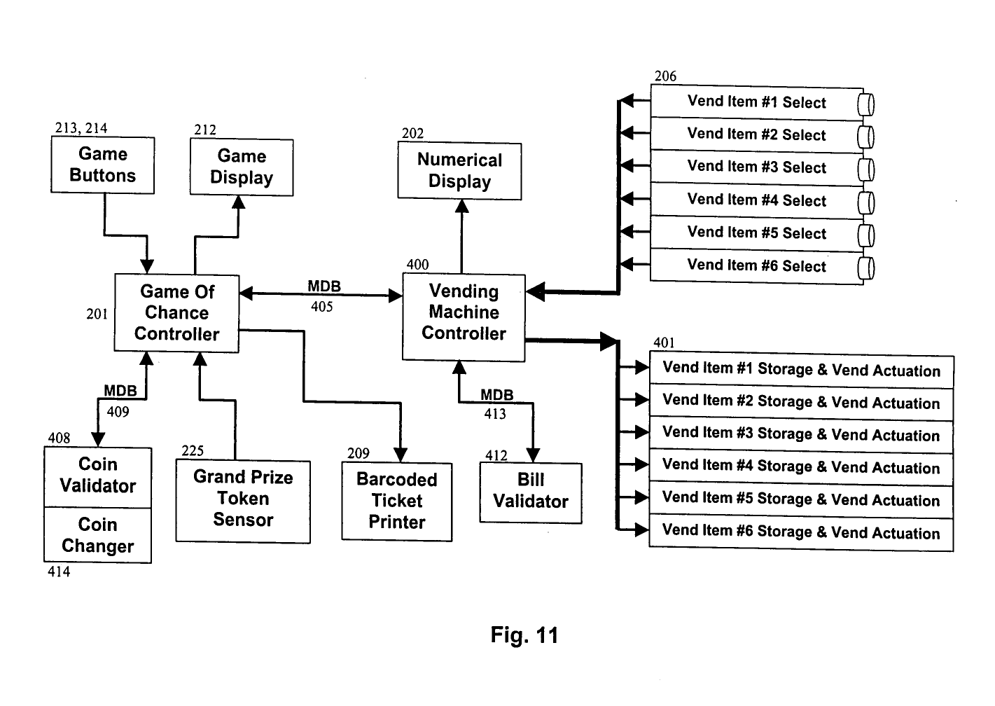

A conventional vending machine 200 for dispensing a variety of beverages is shown in FIG. 3. A patron may normally deposit coins or bill into the vending machine 200 at coin entry slot 204 or bill entry slot 203 for validation by a corresponding coin validator 408 or bill validator 412 within the machine 200, as shown in FIG. 11. The amount of currency validated by the machine is shown on display 202. When sufficient currency has been deposited to enable the machine 200 to vend one of its products, corresponding selection buttons 206 are enabled to permit the patron to make his selection and activate the vending of the selected product through chute 208. Any excess accumulated credit value is returned to the patron by a coin changer 414 (FIG. 11) through coin return 207.

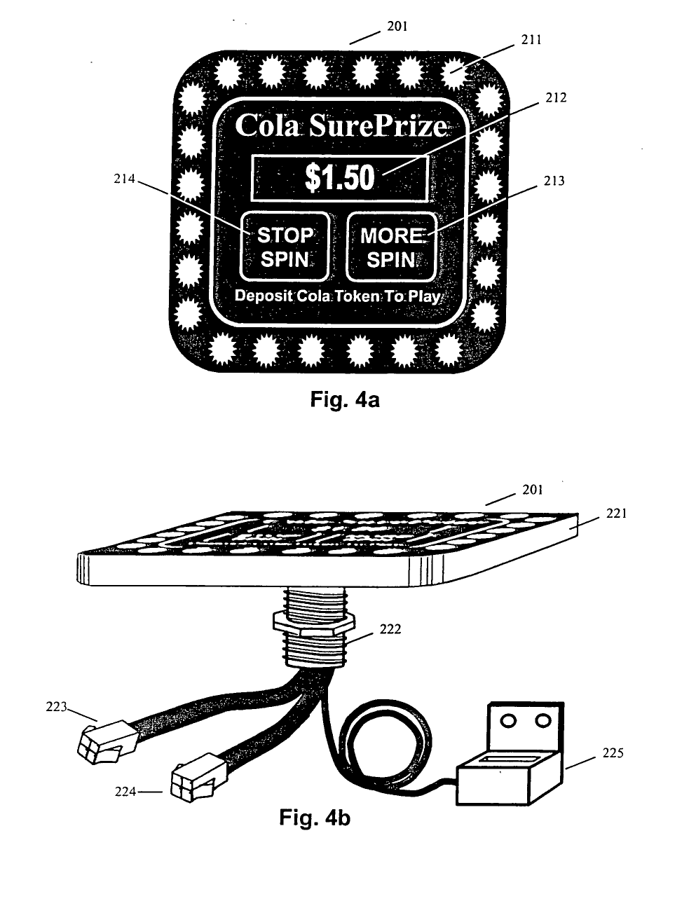

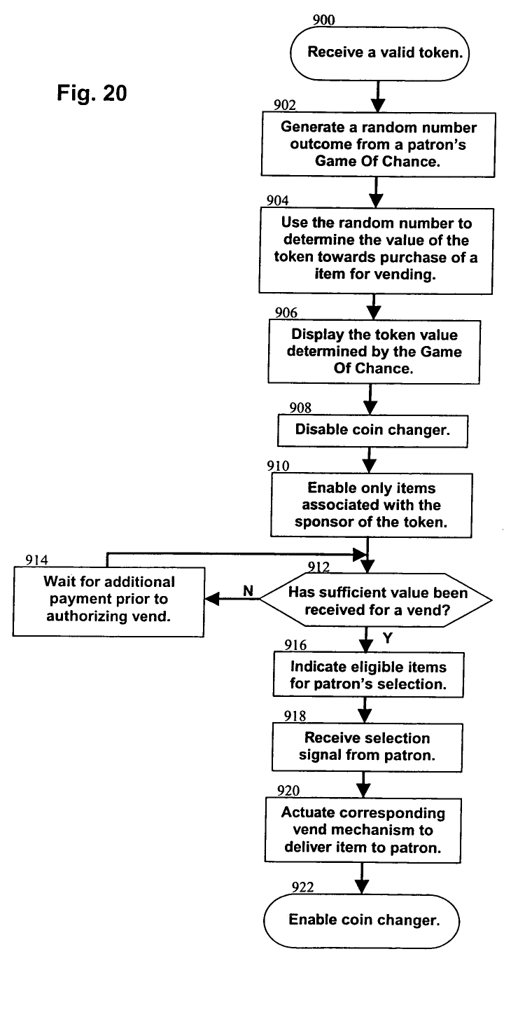

To preferentially attract patrons to consume the beverages vended by machine 200, a game of chance controller 201 (FIGS. 3, 4a, and 4b) is added to the vending machine. For purposes of retrofit compatibility with the millions of vending machines already in the field, the game of chance controller 201 can be separate from the vending machine controller 400, as shown in of FIG. 11, whereas integrating the vending machine controller 400 with the game of chance controller 201 may be more suitable for new machine production. FIG. 20 shows the sequential overall operation of vending machine 200 in the form of a flow chart, including features which will be more fully discussed in the following paragraphs.

Most of today's vending machines have a standardized communication interface called MDB (Multi-Drop Bus) to enable the various machine components to communicate with one another even though they may have been produced by separate manufacturers. The MDB protocol is maintained and managed by the National Association For Automated Merchandising (NAMA) and is here incorporated by reference. MDB is an RS-232 derivative having an optically coupled interface and a master/multi-slave topology. It uses a pair of 6-pin Molex Mini-Fit Jr. connectors 223 and 224 (FIG. 4b) to carry both communications and power. Its protocol allows the controller to know when coins have been received by coin validator 408, to know when bills have been received by bill validator 412, to know how full is the coin changer 414, and to command coin changer 414 to return any excess credit to the patron when the vend cycle has been completed. Part of the MDB protocol includes identification of up to 16 different coin or token types. Not only does this allow for multi-denominational coin operation of the vending machine 200, but it also allows for the use of tokens.

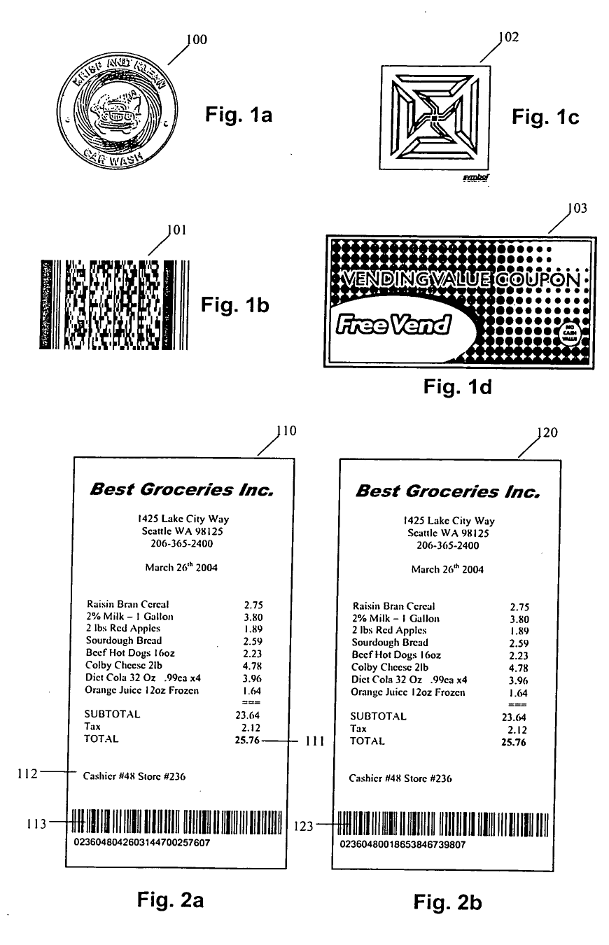

Use of a token having security features, by necessity, is an important integral part of the current invention. When a token can be used to take something of value away from an unattended vending machine, it is imperative that the token be different from tokens used by other local establishments. When cross-play between tokens from two establishments occurs because their token validators are unable to distinguish between them, the establishment having the highest value product or service provided by its token generally finds that it is giving away a lot of his product or service to people bringing in the lower valued token from the other establishment. Security tokens having unique characteristics that can be distinguished by coin validators are described in U.S. Pat. No. 5,046,841 granted Sep. 10, 1991 to Juds, et al. and U.S. Pat. No. 6,021,882 granted Feb. 8, 2000 to Juds, et al. One such example is shown in FIG. 1a as a metallic token having reflective facets minted at specific and differing angles to impart a uniquely identifiable code to the token. The coin validator checks deposited coins and tokens for this security feature and for other more common features, such as the metal alloy and the token's diameter, to determine if the token should be validated. Producing a security token having a bimetal structure wherein its outer periphery is made from a different alloy than its central disc portion is described in U.S. Pat. No. 3,499,739 granted Mar. 10, 1970 to Segal. By mixing combinations of alloys, many distinguishable security tokens can be produced. A token validator capable of distinguishing such bimetal security features is disclosed in U.S. Pat. No. 6,112,876 granted Sep. 5, 2000 to Juds, et al. These patents are incorporated herein by reference.

The game of chance controller 201 is interposed between the coin validator 408 and vending machine controller 400 in order to intercept MDB messages between them. When patrons use coins validated as currency the MDB messages are simply passed on to the vending machine controller 400. The coin validator 408, however, is additionally programmed to validate a special vend token and identify it, for example, as coin type #14 in its MDB message. The game of chance controller 201 is correspondingly programmed to intercept this message without passing it on to the vending machine controller 400. When the game of chance controller 201 intercepts the message indicating coin type #14 has been validated, a game of chance is offered to the patron to randomly determine the value of the token. The game of chance controller 201 preferably includes a numerical game display 212 (FIG. 4a) and optional game buttons 213 and 214 of FIG. 4a and FIG. 11. During the game of chance, the numerical value on the game display 212 takes on a fast changing sequence of numbers, eventually settling out on a specific number. The optional game buttons 213 and 214 may be used by the patron to control how long the numbers on the game display 212 go on changing or how soon they stop. In any case, the final value shown on game display 212 will be the value the patron has won as credit towards his purchase of a beverage from vending machine 200.

Although the credit value the patron has won with his special vend token could be anything, there are practical considerations. Clearly the two most significant values to consider would be zero and one full vend. If the value is zero, then there is no need for the game of chance controller 201 to pass any MDB message to the vending machine controller 400. If the credit value won is one full vend, the game of chance controller 201 must have a “one full vend” message to pass on to vending machine controller 400. In MDB protocol this is accomplished by assigning, for example, coin type #15 to have a credit value of hexadecimal FF, which is defined as one full vend, whatever that may be. When the vending machine is first powered up, the vending machine controller 400 reads the coin assignment tables and other information from coin validator 408 in the process of initializing the system to determine the value of each coin type so that it can later automatically provide the proper credit value for each validated coin or token. Thus, when the game of chance controller 201 later determines the value of a special vend token is to be one full vend, it sends an MDB message to the vending machine controller 400 that coin type #15 has been validated, and the vending machine controller 400 already knows this coin type is assigned the value of one full vend. Alternatively, one could decide to provide the special vend token with fractional vend credit values. A special vend token having fractional vend credit values may be more appropriately called a fractional vend token. In this case the random number generator determining the final value of the fractional vend token must be conditioned to have values between zero and one full vend, and preferably in increments of the value of a coin commonly accepted by the machine. For example, in the United States one would likely use increments of 25¢. In this example one might designate coin type #14 to have a value of 25¢ when it is programmed into coin validator 408. If the game of chance controller 201 determines that the fractional vend token is to have a credit value of 75¢, then the MDB message it would pass on to the vending machine controller 400 would be that three #14 coin types have been validated.

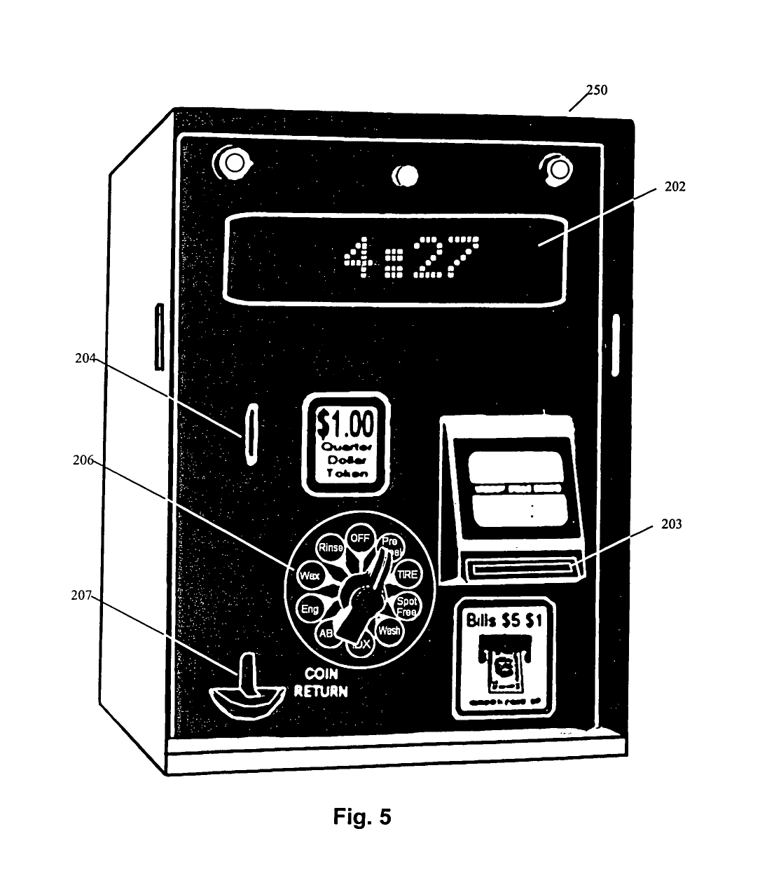

After the game of chance has been completed, the numerical display 202 (FIG. 5) is updated to reflect the credit value amount provided by the game of chance for the fractional vend token. If the total accumulated credit value shown in the numerical display 202 is less than the value of one full vend, then the machine awaits further accumulation of credit value from the coin validator 408 or bill validator 412. During the time after a fractional vend token has been validated and before an item has been vended, the coin changer 414 is preferably disabled to prevent fractional vend tokens from simply being converted into cash. Alternatively, if the accumulated credit value is a mix of value accumulated from the fractional vend token and currency, the vending machine controller 400 may limit any request from a patron for change to the amount of accumulated credit value provided by the validated currency. Logical implementation of either of these change limiting rules is best accomplished within the firmware of the vending machine controller 400 which has the information of the bill, coin, and token types validated, and information of all vending activity. Furthermore, it is the vending machine controller 400 that holds the responsibility for determining what change should be returned to the patron in today's MDB based systems.

There are reasons why one may want to put a minimum value limit on the fractional vend token. First, if it is common knowledge that most all of the time one will get nothing for the fractional vend token, many people will discard them as worthless. For that sector of the population the promotion will be a failure. If, however, one knew that a fractional vend token was always worth at least 25¢, and may be worth as much as one full vend, then even the skeptics would see the value in participating in the promotion. Furthermore, anything that helps keep a promotional game of chance from stepping on any of the various sweepstakes, gambling, and lottery laws is a good thing. Providing a system where everyone wins at least something with an arguably free token makes it pretty hard for any jurisdiction to label it as a system that makes one risk something of value that could be lost in a game of chance.

On the other end of the spectrum, if the fractional vend token has a value only between zero and one full vend, then the promotional effort undertaken may not capture the attention of that portion of the population attracted to the dream of winning a grand prize. In one embodiment of including a grand prize capability, the game of chance controller 201 not only provides fractional vend credits for the token, but additionally can provide a grand prize award at some low predetermined probability. In this embodiment, the same token used for a fractional vend is also used for the grand prize. It is just a matter of the odds and the random outcome of the game of chance. The token validator channels all validated tokens to a drop box within the vending machine in order to prevent re-use of the token in hopes of a higher value outcome. No token held by the machine is distinguishable as a grand prize token from any other because all tokens simply enable the game of chance, and it is the outcome of the game of chance that determines whether to award a fractional vend or a grand prize. In order to provide the patron with some evidence that he has won a grand prize, a barcoded ticket printer 209 (FIG. 11), such as the PSA-66-ST by FutureLogic, is included in vending machine 200 for dispensing a barcoded ticket as a prize voucher representing the grand prize, which the patron takes to a redemption center to claim and collect his grand prize.

A second embodiment of a beverage vending machine offering a game of chance with a grand prize involves having two different tokens distinguishable by the coin validator 408, but visually appearing the same to humans. The coin validator 408 is programmed to accept a fractional vend token as previously described to enable a game of chance limited to a value between zero and one full vend. The coin validator 408 is also configured to reject a grand prize token back to the patron so he may keep it as evidence that he has a grand prize token and take it to a redemption center to claim and collect his grand prize. The MDB command 0BH for polling the coin validator includes a response inclusive of both the coin identity (0 to 15) as well as the disposition of the coin as rejected, sent to coin tubes, or sent to the cash box. However, configuring an MDB validator to use this combination is not currently possible on at least most currently manufactured MDB validators. When the game of chance controller 201 intercepts the MDB message reporting the rejected coin, it employs grand prize token sensor 225 (FIG. 4b), located at the reject chute of the coin validator, to analyze the rejected coin. Circuitry suitable for detecting a unique grand prize token is well known in the art and is included herein by reference. For example, a coin sensor wherein the coin is passed through an electromagnetic field of an inductor in an oscillator circuit and both frequency and amplitude of oscillation are changed is disclosed in U.S. Pat. No. 3,952,851 granted Apr. 27, 1976 to Fougere. Also, a coin sensor having an exponentially damped ringing inductive circuit is disclosed in U.S. Pat. No. 4,625,852 granted Dec. 2, 1986 to Hoormann. If the rejected coin has properties matching that of a grand prize token, the game of chance controller 201 changes its displays 211 and 212 to inform the patron that he has a grand prize token. An audio indicator or message could additionally be used to further inform the patron that he has a grand prize token. The audio indicator may be as simple as an ordinary piezoelectric beeper such as is offered by Panasonic and Mallory, or could be more sophisticated and utilize a piezoelectric speaker driven by the ISD5108 Audio Recorder and Playback IC from Winbond America under control of the game of chance controller 201 to generate a waveform, such as a voice message or musical tones.

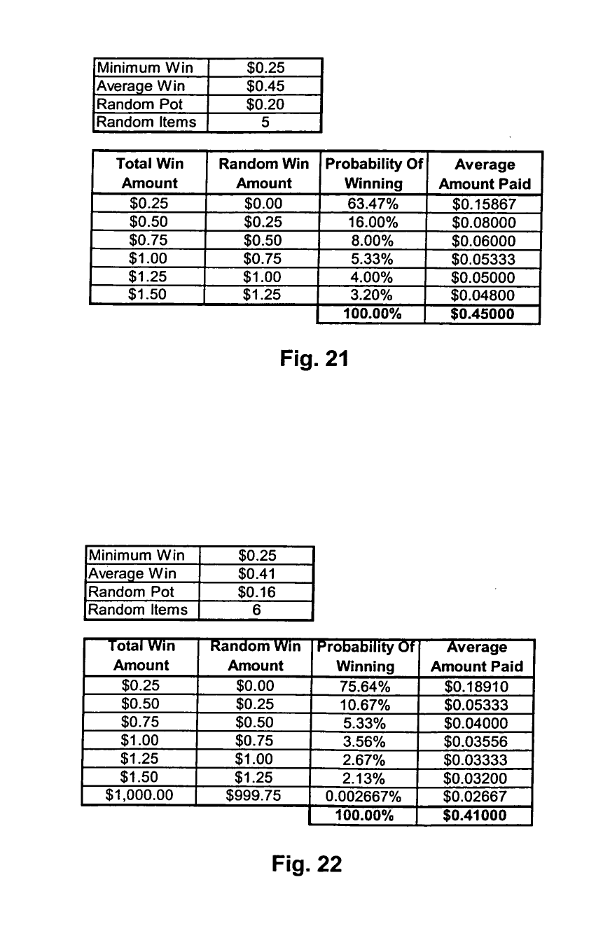

An algorithm for generating the probability for each of the possible values of a fractional vend token is described below through an example and with reference to the table of FIG. 21 which summarizes the example. In order to keep the attention of prospective patrons, on first selects the Minimum Win amount to be 25¢ so that every fractional vend token is worth at least this much. Next selected is an Average Win amount of 45¢, which means that over a large number of fractional vend tokens there will be awarded an average of 45¢ per token to patrons. Since there is a fixed Minimum Win base of 25¢ that will always be awarded, the remaining portion of the 45¢ Average Win amount is called the “Random Pot” having an average value of (45¢−25¢)=20¢. Next selected are the values that are possible to win: 25¢, 50¢, 75¢, $1.00, $1.25 and $1.50 where the first value is the same as the Minimum Win amount, the last value is the same as a full vend, and the increments between them are equal to that of the denomination of a standard currency coin. The Random Win Amount column of FIG. 21 is the Total Win Amount column less the Minimum Win amount. Proceeding further, the fixed part, and the random part are separated. The fixed part is simple: everyone always gets the base award of 25¢. In the random part, there are five non-zero values provision five Random Items that will be drawing value from the Random Pot established earlier as having an average value of 20¢. The Probability Of Winning any of the Random Win Amounts is calculated according to: Probability Of Winning=(Random Pot)/[(Random Win Amount)*(Random Items)]. For example, the Probability Of Winning $1.00 total is the same as the random chance of winning 75¢ in addition to the base value of 25¢ that everyone wins. Using the equation one calculates (20¢)/[(75¢)*(5)]=5.33%. The Probability Of Winning nothing extra is one minus the sum of each of the Probabilities Of Winning one of the additional random amounts, and in this example is 63.47%. Finally, a check for accuracy of the algorithm is performed by calculating the Average Amount Paid for each of the categories by multiplying the Total Win Amount by the Probability Of Winning, and then summing them all. As can be seen in the table of FIG. 21, they all sum to 45¢, which is the desired Average Win amount. FIG. 22 uses this same algorithm, but adds a $1,000 grand prize to the pool of values that can be won and has a different Average Win amount. As can readily be appreciated, this simple algorithm provides a simple means for predicting and controlling the costs of the promotion while affording flexibility in configuration of the terms of the promotion.

In the foregoing example, the fractional share of each of the 5 non-zero Random Win Amounts is equal to ⅕ of the total budget held by the Random Pot. However, the fractional share for each need not be identical. For example, if it were desired to place a relative triple emphasis on winning the $1.50 credit value, then four credit values would each be allocated a standard share, and the $1.50 credit value allocated three standard shares, for a total of 7 standard shares. The allocated fractional shares for each would then be 3/7 for the $1.50 credit value and 1/7 for each of the other credit values. The allocated fractional share then replaces the (Random Items) term in the calculation of the prior paragraph.

Once the probabilities have been determined for winning each of the possible award amounts, the game of chance controller 201 can use these values with a random number generator to determine the amount a patron has won. One very good source of a random number generator in a human activated machine is to use the free running 16 bit timer present in most all microcontrollers. Since there is no knowledge by the patron of the current state of the 16 bit timer and since it runs through all 65,536 values numerous times per second, then if this 16 bit timer value is read at the instant a game of chance is initiated, the read timer value will be random. In the example illustrated in FIG. 21, it would determine that the patron has won only 25¢ if the timer value is less than (63.47%)*(65,536)=41,595. If the timer value is in a 16% wide bracket between 63.47% and 79.47%, which is between values 41,596 and 52,081, then it would determine that the patron has won a total of 50¢ in value for his token. Other won amounts are correspondingly determined. While interaction between the uncorrelated events of a human and a free running 16 bit timer will be quite arguably random, many computed pseudo random number generators are well known in the art that provide values that are sufficiently random for most applications. A sequence of numbers stored in a lookup table may also provide sufficient randomness for this application. For example, we are primarily concerned with making the sequence sufficiently long and random looking that no observer is ever likely to notice a pattern or otherwise abuse its imperfections as a random number source. So long as the source of numbers is reasonably distributed and reasonably long it may be said to be substantially random for this application.

The special vend tokens or fractional vend tokens for use with the beverage vending machine can be made available within, as part of, or attached to the packaging of a product a patron has previously purchased. For example, a 12-pack of carbonated beverage cans may have such a token glued to the inside of the cardboard carrier package. Instructions on the package or token would tell the patron that the token was for use in a vending machine offering products by the same manufacturer and that a game of chance played on the vending machine would determine the value of the token. In this manner the manufacturer of the carbonated beverage creates a promotional attraction to their brand, both at the grocery store for the 12-pack and at the vending machine. Although the foregoing description has focused on that of a beverage vending machine, the same principles of operation can obviously be applied to vending machines in general, whether they are for beverages, snacks, or other miscellaneous items.

The game of chance controller 201 of FIG. 4 preferably provides a visually identifiable display when idle in order to indicate to prospective patrons that the vending machine 200 has a game of chance installed. For example, it could have a series of LEDs 211 about its periphery that chase, twinkle, change color, or have other such visually interesting properties. Control of an array of such LEDs by firmware driving a parallel port of a microcontroller is fairly simple and is well understood in the art.

The game of chance controller 201 of FIG. 4b is preferably constructed in a manner allowing for easy retrofit into existing vending machines in the field. A relatively thin face plate 221 encloses the circuitry of the game of chance controller 201 beneath a thin graphic overlay on the surface. On the back side, a threaded tube 222 provides a means to bring wires into and out from the circuitry, and means to mount and secure the game of chance controller 201 to the vending machine 200 via a single drilled hole. Standard MDB connectors 223 and 224 provide the physical electrical interface with coin validator 408 and vending machine controller 400, including operating power and communications. So long as grand prize token sensor 225 is required, it is preferably located at the reject chute of the coin validator, but may alternatively be built into the face of the game of chance controller 201 on machines where space restrictions prohibit the preferred location. For example, the More Spin button 213 could be replaced by a sensor zone where the patron could hold his token for analysis by an underlying inductive sensor to determine if the token is a grand prize token. The preferred embodiment in a factory installation on a new machine would include elimination of the need for an add-on grand prize token sensor 225 by building it into coin validator 408 through extending its functionality to allow for simultaneously reporting both a coin rejection event and the identity of the token.

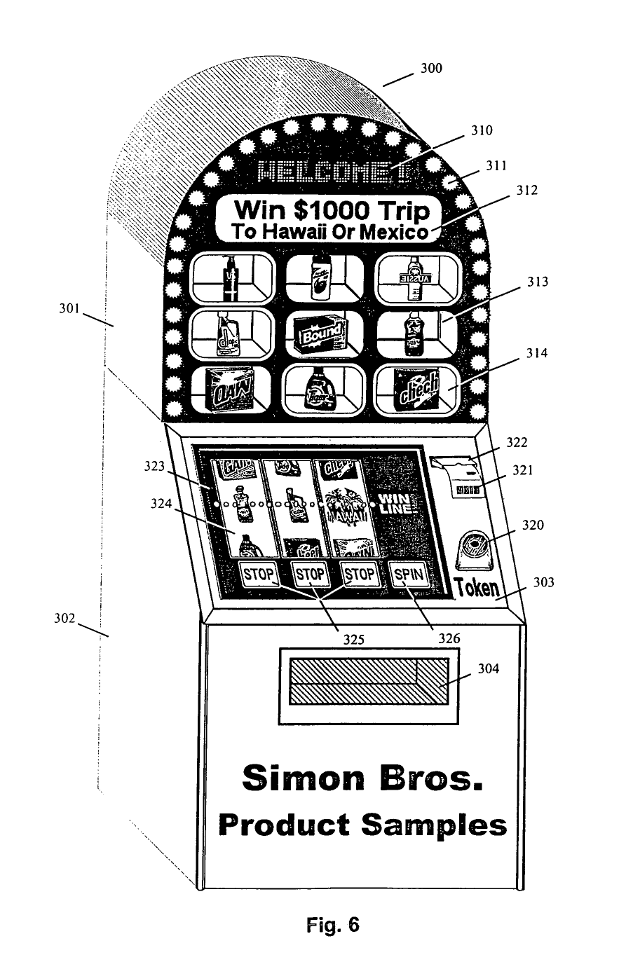

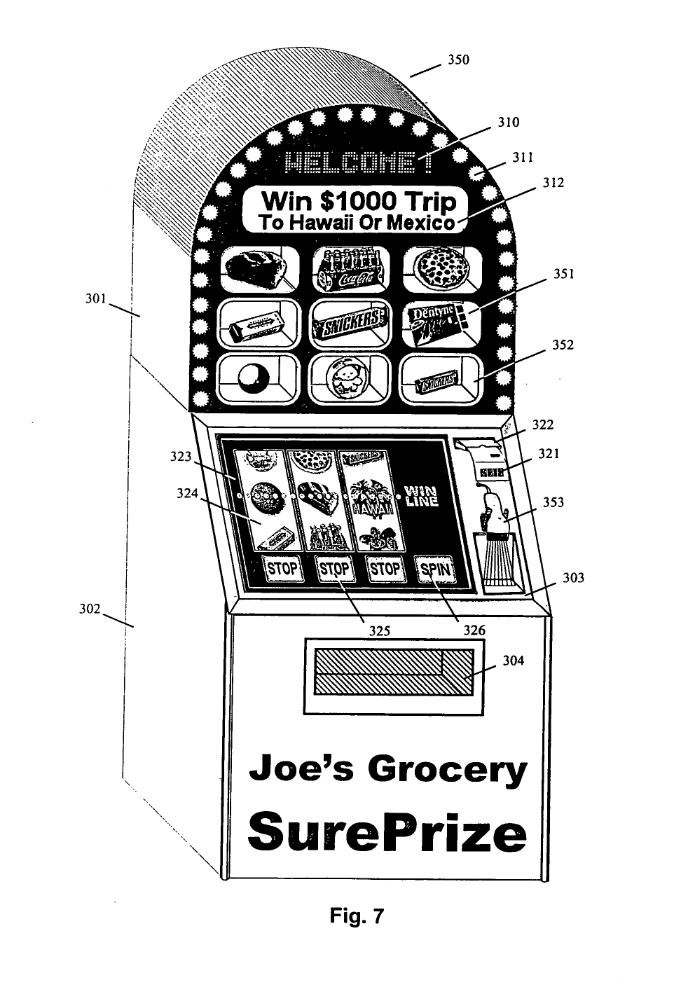

Another embodiment of a vending machine having a game of chance is the product sample vending machine 300 of FIG. 6 and the very similar customer appreciation vending machine 350 of FIG. 7, both of which will be described together, with their differences noted where significant. The major common construction features of product sample vending machine 300 and customer appreciation vending machine 350 include an upper section 301 primarily for display and storage of items to be vended, and a lower section 302 that primarily interfaces with the patron, houses the vending machine control computer, and vends items as required to the patron.

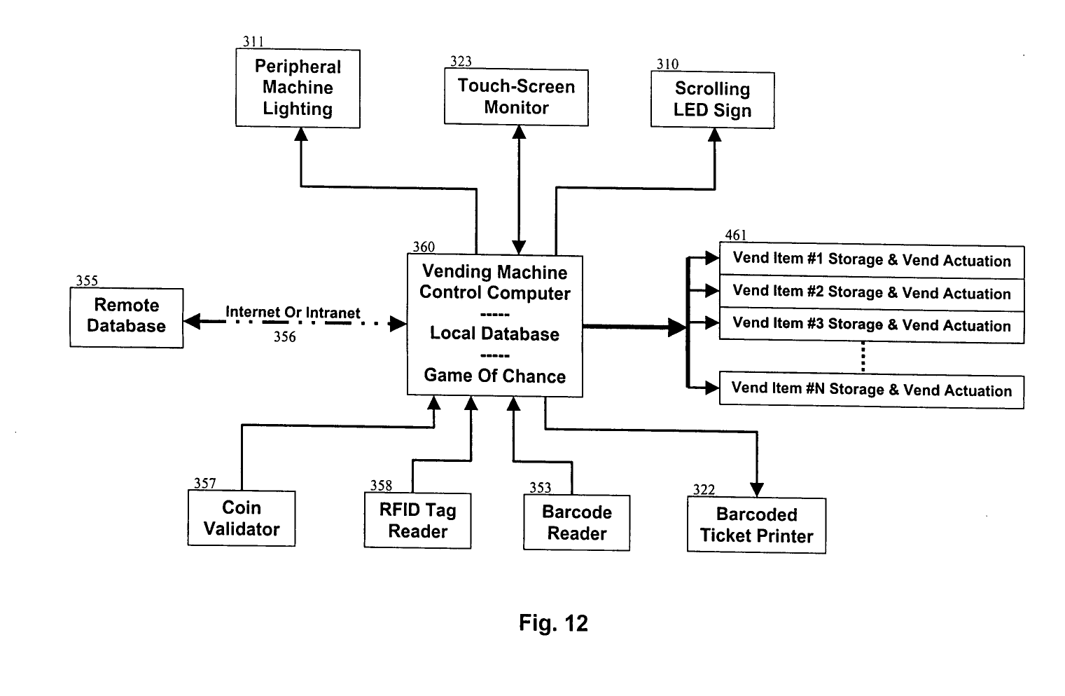

A band of peripheral machine lighting 311 having individual lights that chase, twinkle, change color, or have other such visually interesting properties is used to attract prospective patrons. As previously indicated, control of an array of LEDs by firmware that drives a parallel port of a microcontroller is fairly simple and is well understood in the art. As shown in the vending machine block diagram of FIG. 12, the peripheral machine lighting 311 may be controlled by the vending machine control computer 360 to synchronize the lighting effects with the current state of the game of chance. Control of the peripheral machine lighting microcontroller by the vending machine control computer 360 can easily be implemented via an RS-232 port communication link, which is pretty much standard equipment on most microcontrollers and computers. If custom control is not desired, one may alternatively opt for a commonly available static or chasing light rope to perform this function.

A scrolling LED sign 310 provides information to further help attract prospective patrons. Messages such as “12 VACATION TRIPS WORTH $1,000 WON THIS MONTH IN TEXAS”, or “7 BOXES OF KLEEN DETERGENT WON HERE THIS WEEK”, or “FREE PLAY TOKENS IN PRODUCT PACKAGES AVAILABLE AS MARKED” may be scrolled. Most commonly available LED message signs can be remotely programmed through an RS-232 serial port to change the message content or to change a special effect, such as dissolves or entry direction. Connection to and control by the vending machine control computer 360 through one of its RS-232 serial ports is thus easily accomplished. One such scrolling LED sign is available as model BS-820 from IDX. In order to form messages involving the recent history of product or prizes vended to patrons by the machine, the vending machine control computer 360 keeps a record in its internal local database of all items dispensed by the vending machine. The messages relating to items dispensed can be automatically assembled by an algorithm that searches the database for vends made in a prior predetermined period of time, such as a day, a week, or a month. The quantity of each of the items vended during this period of time is totaled, and the results of one or more of the most significant totals are formatted into a message. Significance may relate to a simple total, the highest valued item, or it could relate to a combination of value and quantity. For example, one might always choose to report the history of recent winnings of the grand prize so long as it is greater than zero for the chosen time period. Correspondingly, one might choose to never report how many gumballs were won even though more of them were dispensed than any other item. One might also just simply choose to rotate between reporting the history of recent winnings for the four highest valued items. The formatted messages are assembled from their constituent fragments containing the period of time, the item name, and the quantity using common string arithmetic operators, such as concatenation, trimming, and time formatting. The resultant messages are then transmitted to the scrolling LED sign 310 for display. Update of the message is programmed to occur automatically on at least a daily, if not hourly basis. Similarly, display messages can be automatically constructed from information available from a network of such vending machines. Information from each machine is transmitted on a regular basis from each of the machines over an internet or intranet link 356 to a remote database 355, and information regarding the performance of all machines on the network is retrieved from the remote database 355 for generating and formatting messages to be transmitted to and displayed on scrolling LED sign 310.

The upper section 301 of product sample vending machine 300 and customer appreciation vending machine 350 have a lighted display of items 313, 314, 351, 352 and others that can be vended. These display items, as shown in FIG. 6 and FIG. 7, are illuminated in a random manner during the game of chance and when the machine is idle in order to help attract attention to the machine. When the game of chance is complete, only the items from which the customer may select for vending are preferentially illuminated. For example, the outer portion of the area holding sample box 314 is illuminated while it is not for sample bottle 313. The lighted display of items may be constructed of individual cubby holes holding items that can be selectively illuminated, or it may be constructed as a backlit graphics panel having images of the items and selective backlighting for each item, or the display may be an LCD panel providing computer controlled graphic images. The later has the advantage of being able to change the display remotely by downloading new graphic contents to the vending machine control computer 360 rather than physically changing the display in each such machine. Grand prize display 312 is selectively illuminated in one of the same manners as described above.

Product sample vending machine 300 and customer appreciation vending machine 350 have within them storage and vend actuation means 461, as shown in FIG. 12. Many suitable mechanisms are known in the art for the storage and vend actuation of a variety of food and beverage items. A vending machine having a plurality of vertically spaced inclined shelves for vending beverages is disclosed in U.S. Pat. No. 6,199,720 granted Mar. 13, 2001 to Rudick. A vending machine and mechanism for vending bulk candy, gumballs and the like is disclosed in U.S. Pat. No. 5,833,117 granted Nov. 10, 1998 to Kovens, et al. A table top machine for vending beverages, candy bars, bags of chips and the like is disclosed in U.S. Pat. No. 6,330,958 granted Dec. 18, 2001 to Ruskin, et al. These patents are incorporated herein by reference.

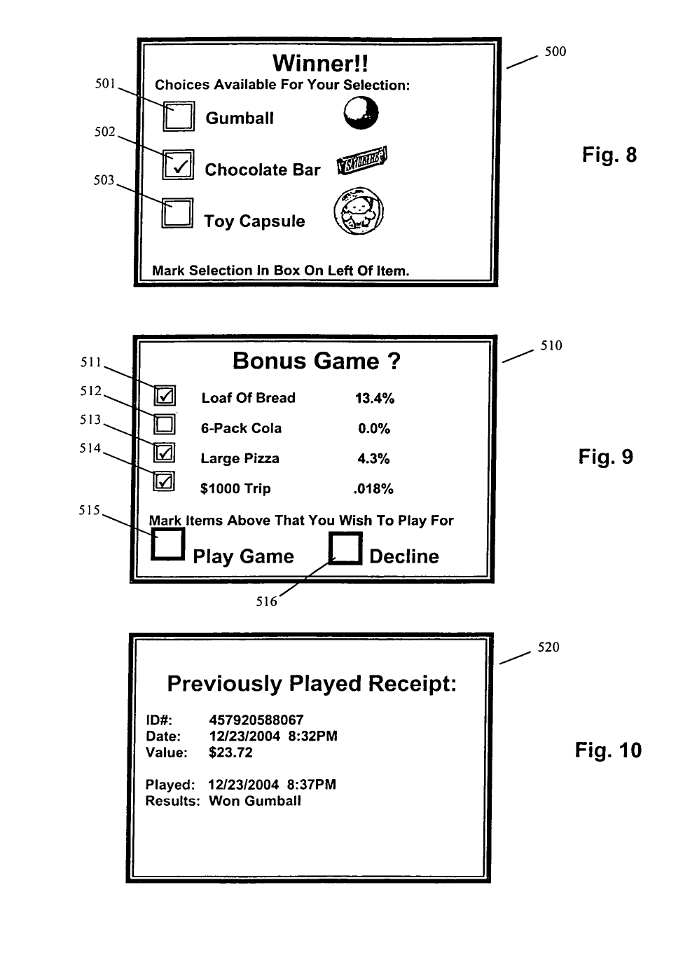

In the lower section 302, ov vending machine 300 and 350, a touch-screen monitor 323 mounted on inclined panel 303 provides an interface for the patron to play the game of chance and to make a selection of an item to vend. The touch-screen monitor 323 interfaces to the vending machine control computer 360 with the same video standard video interface used by computer monitors, such as VGA, SVGA or XGA, and additionally uses one of the same pointing device interfaces used by a computer for devices such as a mouse or trackball, including RS-232 or USB. Touching the screen invokes the same response as pointing and clicking with the mouse. ELO TouchSystems, for example, offers numerous integrated LCD touch-screen panels suitable for mounting in OEM products. The touch-screen monitor 323 thereby is able to provide virtual buttons 325 and 326 for use by the patron to operate the game of chance. When the game of chance has been completed, screen 500 of FIG. 8 is displayed on touch-screen monitor 323 for the patron to select from among one or more items to vend from the machine. By touching the screen at locations 501, 502, or 503 an item is selected. After the patron makes his selection, the item is either immediately vended to the patron from opening 304, or a barcoded ticket 321 is printed from ticket printer 322 as a prize voucher if the item cannot be directly vended from the machine.

A product sample token is required to operate product sample vending machine 300. The product sample token is made available within, as part of, or attached to the packaging of a product a patron has previously purchased. A product sample token may be of the type previously discussed wherein it is metallic or plastic, of disk shape, has at least one distinguishable security feature to associate it with a sponsor, and which can be validated by a suitable coin validator 357 of FIG. 12. Such a token may, for example, be dropped into a box of laundry detergent during the box filling operation at the factory. Eventually the patron finds the token and brings it to the store having product sample vending machine 300 and inserts it into slot 320 which directs it to coin validator 357 to enable the game of chance if the token is valid. The IDX Model X-10 coin validator, for example, validates a token based on its alloy, diameter, and an optical code minted in the token's surface, referred to as X-Mark. It is important to be able to associate a specific token with a specific sponsor so that the sample vending machine is only enabled by tokens provided by the sponsor of product samples within the vending machine. The X-Mark system allows for many distinct tokens to enable association of a specific token with a specific sponsor so that well known cross-play security problems with simple tokens can be avoided. When the patron inserts the product sample token into slot 320, a validated token is retained within product sample vending machine 300 so that it may only be used once. A rejected token not validated by coin validator 357 is returned to the patron through opening 304.

A product sample token may also take the form of a barcode incorporating a serial number, such as that shown in FIG. 1b for reading by barcode reader 353 shown in FIG. 7 and FIG. 12. A barcode style product sample token may be in the form of a coupon inserted into the product packaging, a label attached to the product package, or just printed directly onto the product package. Most barcode printing software, such as that available from Avery Dennison Corporation, provides serialization capability for 1D and 2D barcodes. When barcode reader 353 provides read data to the vending machine control computer 360, it validates it by verifying the portions of the data that confirm the sponsor's identity and comparing the serial number portion of the read data with serial numbers previously read and stored in its local database. If the serial number has been previously read, then it is not validated. Unlike the disk shaped token that is deposited into and retained by the vending machine after validation, a barcode used as a token remains in the hands of the patron after it is read, and an attempt to possibly validate it again may be made. Recording the read serial numbers in a database thus provides a means to prevent multiple validation of a specific product sample token of this form. Similarly, in a network of machines, read serial numbers can be reported to a common remote database 355 via an Internet connection 356 and accessed by any machine on the network such that each serialized barcoded product sample token may be validated only a single time. If the product sample token has been previously used to play a game of chance on this machine, touch-screen 323 displays information indicating that the serial number has been previously used to play the game of chance, when it occurred, and what the results of the game of chance and item selection were. There are numerous sources for barcode readers, one of which is Symbol Technologies.

A product sample token may also take the form of an RFID tag from a product package, such as the one shown in FIG. 1c manufactured by Symbol Technologies. RFID tags compliant with the EPC96 standard carry a product identification code as well as a product serial number. The data read from an RFID tag used as a product sample token is treated the same as previously described for the serialized barcode style product sample token. There are numerous sources for RFID tag readers, one of which is Symbol Technologies.

A product sample token may also take the form of a token note as shown in FIG. 1d. Just as metal tokens were made to mimic coinage currency, so also have there been so-called token notes made in the shape of paper money. Today's bill validators look not only at the reflective image properties, but also at the transmitted image properties wherein the light passing through the token note is evaluated. The security is provided by tight control over the image pigments and paper characteristics in both reflected and transmitted colored light. Many bill validator companies print fairly secure token notes for use by their patrons in their businesses. Such a token note could be easily packaged with a product as are ordinary coupons. The vending machine block diagram of FIG. 12 has a coin validator 357, an RFID Tag reader 358, and a barcode reader 353, but does not specifically show a bill validator. However, only one of these is required for functionality of the machine.

The customer appreciation vending machine 350 of FIG. 7 also requires an enabling means for a patron to play its game of chance. A first such means to enable customer appreciation vending machine 350 utilizes a barcode reader 353 to read information from a barcode 113 or 123 (FIGS. 2a and 2b respectively) on a patron's purchase receipt 110 or 120 to determine a retail store's identity, its location, the time, the date, and the patron's purchase amount. Receipt 110 of FIG. 2a has a barcode 113 which directly encodes the cashier station and store information 112, the total purchase amount 111, and the time and date. Receipt 120 of FIG. 2b has a barcode 123 which provides a transaction ID which is read by barcode reader 353 for transmission to the vending machine control computer 360 of FIG. 12. The vending machine control computer 360 contacts a remote store database 355 via network link 356 to retrieve additional information about the purchase, including at least the purchase amount. The information is then compared with the information from prior read receipts stored in the local database of the vending machine control computer 360 and the receipt is validated only if this is the first time the receipt has been used to enable a game of chance. If the receipt has been previously used to play a game of chance on this machine, touch-screen 323 displays screen 520 of FIG. 10 to indicate that this receipt has been previously used to play the game of chance, when it occurred, and what were the results of the game of chance and item selection. Likewise, if the information read from the barcoded receipt is otherwise invalid for any reason, the read information and the reason it is invalid for playing the game of chance is displayed on touch-screen 323.

A second means to enable customer appreciation vending machine 350 utilizes a token provided to a patron by a proprietor at the point of sale. The token is metal or plastic, is coin shaped, and has at least one distinguishable security feature identifiable with the proprietor, such as token 100 shown in FIG. 1a. The token validator is a conventional coin validator 357 suitable for authenticating the security feature of the token 100. As previously indicated, the IDX Model X-10 is an example of a coin validator utilizing alloy, diameter, and an optical code, referred to as X-Mark, minted in the token's surface. It is important to the proprietor to enable the customer appreciation vending machine 350 only when their own sponsored tokens are deposited into coin slot 320 for validation by coin validator 357. The proprietor could provide each patron with a single token for each purchase. Alternatively, the proprietor could provide a patron with one token for each $10 of purchase, thus showing more appreciation for the proprietor's better customers.

A third means to enable customer appreciation vending machine 350 utilizes a customer ID tag. Many retail stores have provided their customers with a tag for their key chain having a customer ID barcode printed thereon. They are typically used at the check stand to provide their registered customers with additional savings. The customer ID could also be carried by an RFID tag in the form of a key fob. Such RFID tags carrying a customer ID number have been used to enabling automatic billing at gas pumps of some service stations and for other such similar applications. To read the customer ID carrier in the first case requires barcode reader 353 to identify the patron, while in the second case requires RFID tag reader 358 to identify the patron. By offering registered customers one free play of the game of chance per day or per week, patrons have an additional incentive to register and to come to the store. A free play also allays any concern that the customer appreciation vending machine 350 combines all of the elements of prize, chance, and consideration so heavily regulated by law. A record of when each customer ID was used for a game of chance is kept in the local database of the vending machine control computer 360 to limit the customer's frequency of free play of the game of chance. The local database of each machine can also be uploaded to the remote database 355 via network connection 356 to enable responses to enquiries from each machine about the use of a particular customer ID among all network connected machines within a prior predetermined period of time.

The game of chance may take any of many forms commonly known to the casino gaming industry. The touch-screen 323 of FIG. 6, for example, shows a video version of a reel type game and provides the patron with virtual button 326 to start the game, and virtual buttons 325 to stop each reel. As in the casino gaming industry, the specific graphics are unimportant to the proprietor. What is important is that the probabilities of winning items are predetermined, statistically well controlled, and yet random for any particular game played. During a game of chance, a random number generator is used to determine the outcome of the game. When the initial game of chance has been completed, the patron may optionally be offered a bonus game of chance to risk what he has already won to possibly win a more valuable item. Perhaps someone who has won a candy bar is feeling a bit more nutritional minded and would prefer to take a chance at winning a loaf of bread or other prize rather than have to accept the candy bar. Screen 510 of FIG. 9 shows how a bonus game of chance would be offered. If the patron does not want to play the bonus game of chance, he selects the Decline virtual button 516 and is then presented with screen 500 for selecting among items qualified by the outcome of his game of chance. If the patron wishes to try the bonus game of chance, the probabilities of winning any of the higher valued items are shown to him adjacent to the item names, and he has the option to de-select any of the items using the checkbox buttons 511, 512, 513, and 514 to the left of the item names. De-selecting some of the items proportionally increases the chances of winning the remaining items in a manner that is cost neutral to the proprietor. When the patron is ready to play the bonus game of chance he presses the Play Game virtual button 515. The outcome is again determined by a random number generator and the predetermined probabilities for winning each of the items.

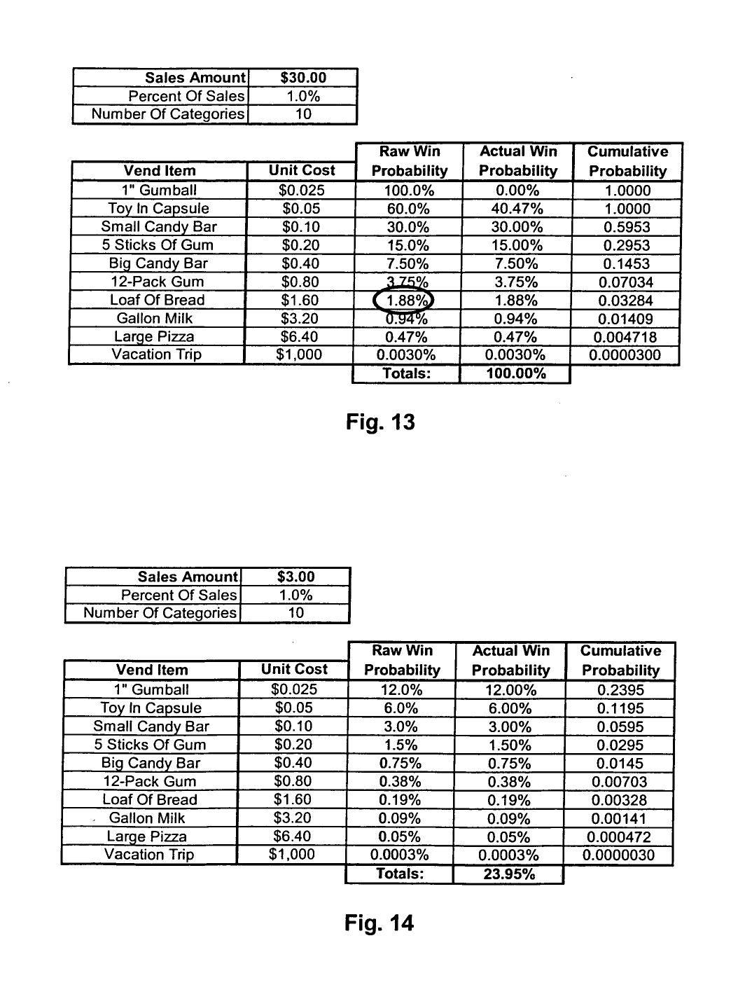

An algorithm for generating the probability for each item that can be won in the customer appreciation vending machine 350 is described below through an example and with reference to the tables of FIG. 13 and FIG. 14 which summarize the example. In these tables, there is an upper portion indicating that in the case of FIG. 13 the sales amount was $30, whereas for FIG. 14 the sales amount was only $3. In both cases one percent of sales is budgeted for return to patrons from the customer appreciation vending machine 350, and in both cases there are a total of ten items that could be won. Multiplying the sales amount by the budgeted percent of sales gives a mean total budget for dispensing won items. Specifically the mean total budget for dispensing won items for each is: (1%)($30)=($0.30), and (1%)($3)=($0.03) respectively. The first column of the lower portion of each table has an item description. The second column holds the Unit Cost, or value, of the item. The Raw Win Probability for each item category is equal to the mean total budget divided by the Unit Cost of the item and again divided by the number of item categories. By dividing by the number of item categories, each item category is allocated a 10% equal fractional share of the mean total budget. Although in this example all allocated fractional shares are equal, they need not be equal should one choose to emphasize one or more items over the others. However, in the end, the sum of all fractional shares should be unity. In FIG. 13, the Raw Win Probability of the circled value is calculated as ($30)(1%)/(10)/($1.60)=1.88%. The calculation for the 1″ Gumball would normally produce a value of 120%, but is limited to 100% in the table because probabilities must inherently be limited to values between 0% and 100%. The column for Actual Win Probability takes into account the fact that the cumulative probability for all items cannot exceed 100%. The Actual Win Probability is the Raw Win Probability limited by one minus the Cumulative Probability of all of the higher valued items. In the example of a $30 sales receipt this means that the lowest valued item will never be selected unless a patron decides he favors the lowest valued item over a higher valued item. For example, the cumulative probability for all items from the Vacation Trip to the Small Candy Bar is 59.53%, leaving a maximum of 40.47% probability for the Toy In Capsule.

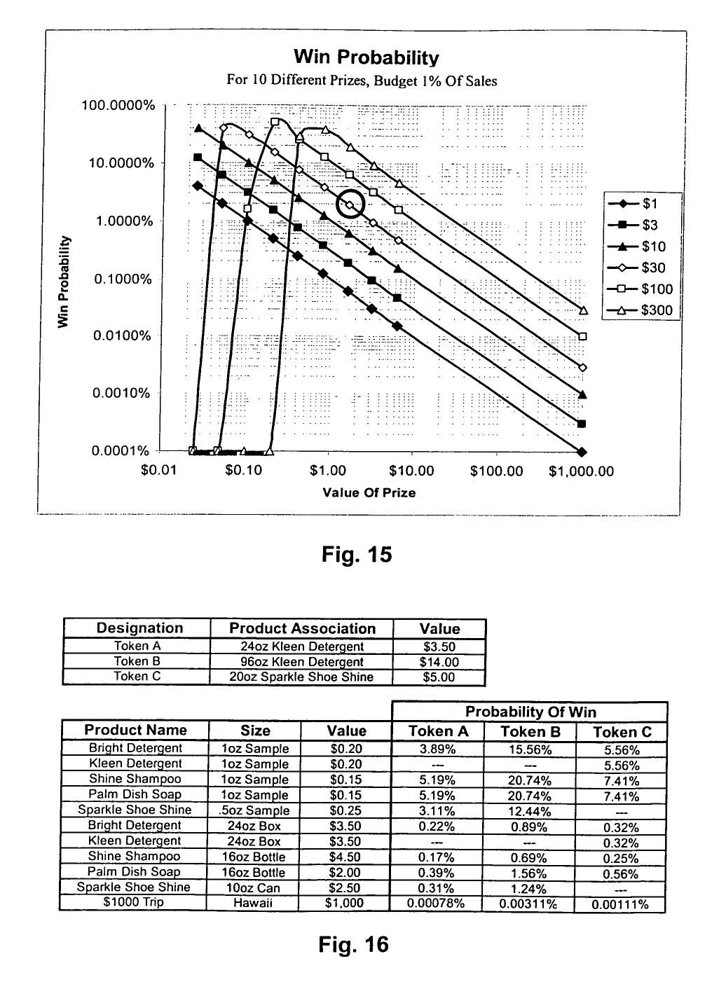

In the foregoing example, by examining the tables one can see that the Raw Win Probability in FIG. 14 is one tenth that of the Raw Win Probability in FIG. 13, as it should be since the Sales Amount is in the same proportion. In FIG. 13 there is a 12% probability of winning the 1″ Gumball, and a cumulative probability of 23.95% of winning anything at all. The game of chance produces an outcome which is based on a random number. In the examples of FIG. 13 and FIG. 14, the random number generator is programmed to produce and evenly distributed set of values greater than or equal to zero, but less than one. The random number is then compared with the Cumulative Probability for each of the item categories. If, for example, the random number was 0.07327, then the winner from FIG. 13 would be the Big Candy Bar, and the winner from FIG. 14 would be the Toy In Capsule because the random number is less than the Cumulative Probability for that item, but more than that of the next highest value item. The graph of FIG. 15 shows the Win Probability for a plurality of prize values for six different sales receipt values showing the characteristic differences described above.

Just as for the fractional vend token previously described, in order to help ensure patrons don't loose interest from coming up empty too often, one can additionally impose the rule that every patron with a sales receipt, no matter what the amount, will always win at least a 1″ Gumball. One simple solution is to always set the Actual Win Probability for the lowest valued item equal to one minus the Cumulative Probability for the second least valued item. A slightly more complex method would be to use the same methodology previously described for the fractional vend token having a Minimum Win amount wherein the value of the 1″ Gumball becomes the Minimum Win amount.

In the case where the customer appreciation vending machine 350 is enabled by a customer ID number, a mean per-vend budget for vending won items to patrons must be determined. One might, for example, choose to set the per-vend budget to one cent, which would be the same as having a one dollar sales receipt and providing 1% of that amount for the budget. Furthermore, because there is no purchase associated with the game of chance, one might choose not to always vend at least the most inexpensive item. Otherwise, completing the probability calculations is the same as in the foregoing example, including deciding on the allocated fractional share of each of the items, and then setting the probability of winning an item in a category equal to the per-vend budget for all items multiplied by the item's allocated fractional share and divided by the cost or value of the item.

As previously indicated, the screen 500 of FIG. 8 offers the patron more than one item for his selection. In the foregoing example calculations, the implication was that there would only be one item category that can be won because the probabilities are calculated to be mutually exclusive events. However, as a mater of practicality, a patron may actually prefer to select an item of lower value than the one won for some unknown personal reason. Offering additional items of lower value to the patron thus provides added satisfaction for patrons and reduces the cost of operation for the proprietor.

In the bonus game of chance the probability for winning each of the offered higher valued items having a checked box in FIG. 9 is predetermined using an algorithm which sets the sum of the probabilities for winning each item multiplied by their respective values equal to the value of the item that already has been won. For example, assume that in the initial game of chance a candy bar of value 54¢ was won. Statistically, over many such bonus games, the mean total budget for winning items in the bonus game of chance should be 54¢. By then allocating the fractional share each item will have of this 54¢ mean total budget to each of the three selected items 511, 513, and 514, and assuming they will equally share the budget, then the allocated fractional share of the mean total budget is 18¢ for each of these three item categories. The probability for winning an item in a category is then set as its allocated fractional share of the mean total budget divided by the value of the item. Thus, if the value of a loaf of bread is $1.34, the large pizza is $4.19 and the trip is $1,000, then the corresponding probabilities for winning each of these items is: (18¢)/($1.34)=13.4%, (18¢)/($4.19)=4.3%, and (18¢)/($1000)=0.018% respectively.

In the product sample vending machine 300, many of the items that can be won consist of small packaged samples of products the sponsoring manufacturer wishes to promote. Additional interest in using the product sample vending machine 300 may be achieved by providing a patron with the opportunity to win a retail sized version of the product, or even a vacation trip to an exotic destination. In large volume, product samples have value of about 10¢ to 30¢ whereas a large retail package of the product may sell for $5 to $15. Thus a sample product is worth on the order of 2% that of a full large sized retail product, and perhaps about 6% that of a smaller sized retail package of the product. Much like the previously described beverage vending machine 200 and customer appreciation vending machine 350, the probability of winning a sample product, full product, or exotic vacation trip items is inversely proportional to the value of the item, and the mean total budget for vending any of these items is allocated among the items such that the sum of the allocated fractional shares of the mean total budget for all items is unity. The allocated shares may be equal, or may be in disproportion according to any particular additional emphasis the sponsoring manufacturer may so desire. Like the other machines, one may decide that it is important that no patron walk away from the machine empty handed, in which case one may use the algorithm previously described involving the separation of the Minimum Win Amount and the Random Win Amount in order to maintain a strict budget. Alternatively one may simply adjust the Actual Win Probability for the lowest valued item to be equal to one minus the Cumulative Probability for the second least valued item as previously described. The mean total budget is set by the sponsoring manufacturer to meet its strategic marketing needs. One such strategy, for example, could be to first provide sample vend tokens only in the large sized product packages. Second, to calculate, for example, that the average value of the large sized products is $7.25. Third, to determine, for example, that the company is willing to budget 1% of sales for this activity. Realizing that only 30% of sales are in the large sized products and only 50% of all tokens will likely ever be redeemed, the mean budget per-vend is then set to ($7.25)(1%)/(30%)/(50%)=48.33¢ and will more often vend higher valued items or prizes.

The table of FIG. 16 shows an additional means for valuing product sample tokens used to enable product sample vending machine 300 wherein there are three different product sample tokens, each associated with a particular product having a particular value. Token B, for example is associated with the 96 oz package of Kleen Detergent having a retail value of $14. The Probability Of Win columns associated with each of the tokens are calculated as previously described, assuming a 2% of sales mean per-vend budget and having an evenly allocated fractional share for each of the 9 item categories. As can readily be appreciated from the table, because each of the three tokens is associated with the value of the product from which it was obtained, higher win probabilities are produced for the product sample tokens associated with products of higher value.

In both the product sample vending machine 300 and the customer appreciation vending machine 350 there are items that can be won by a patron which may not be convenient or even possible to hold within the machine and vend on demand to the patron. Items such as small sample bottles of detergent, gumballs, candy bars and the like can be stored within and instantly vended by the machines. However, items such as a large box of detergent, a pizza, or a vacation trip to Hawaii cannot be stored within and instantly vended by the machine. Barcode ticket printer 322 of FIG. 12 provides a means by which these vending machines may provide the patron with a barcoded ticket 321 of FIG. 6 as a prize voucher for such items. The prize vouchers for items such as a pizza are redeemed by the food retailer at the convenience of the patron. A grand prize such as a vacation trip to Hawaii would likely have a separate redemption process since such items are not normally sold in establishments where one of these vending machines is likely to be present.

In one final embodiment of the present invention a time-metered service vending machine 250 of FIG. 5 offers a game of chance to patrons for providing additional bonus time to the patron during the vending of selected services. A self service carwash is a common application for such a machine. The housing of the time-metered service vending machine 250 typically is constructed from heavy gage stainless steel for protection and durability in this unattended environment. A patron deposits coins or tokens into the coin slot 204, or bills or token notes into bill slot 302. As payment is deposited, the accumulated value is displayed on LED display 202, which is usually an integral part of a display-timer control unit. The display timer grants a predetermined amount of service time for a predetermined amount of payment. For example, the display-timer control unit may be configured to provide 4 minutes of service per dollar of payment. When sufficient payment has been made, the display 202 shows the service time remaining for vending a service selected by rotary switch 206. The display-timer control unit activates an output to control a remote actuator, such as a relay, motor, or solenoid to vend the selected service.

A game of chance may be enabled in a time-metered service vending machine 250 by either the validation of a promotional token, or by validation of some predetermined threshold amount of payment for time-metered services. A patron may receive a promotional token in the mail, or in any number of other ways from a proprietor trying to stir up new interest in his business. Alternatively, providing an amount of bonus time after receiving a certain higher level of payment is not a new concept for encouraging existing customers to commit to more than the minimum amount of money or equivalent token value to get the machine started. However, providing a random amount of bonus time, and occasionally a significant amount of bonus time, not only has value for the patron, but also adds a little fun and interest to the process. When a game of chance is enabled, the display 202 first indicates that a game of chance has been enabled, and then displays a rapid sequence of different time values, eventually settling on a bonus time amount to be granted to the patron and added to any other service time for which payment was previously received. The game of chance has a predetermined set of time values that can be granted, and is managed with a predetermined minimum bonus time, such as 10 seconds, and a predetermined average bonus time, such as 20 seconds. A series of possible bonus time values that can be granted are preselected. One example of a series of possible bonus time values is: 10 seconds, 20 seconds, 30 seconds, 45 seconds, 1 minute, 2 minutes, 3 minutes, and 5 minutes. As should be readily apparent, there is a close analogy between the bonus time provided by a promotional token in this embodiment, and the credit value provided by a fractional vend token in the embodiment of the previously described beverage vending machine 200. The same principles apply for managing the probability distribution of bonus time amounts such that the average value of a large population of granted bonus time amounts closely approximates a predetermined average value.

The steps for setting the probability distribution function of bonus time values that can be granted include a) setting a predetermined average bonus time value (Avg) to grant, b) setting a bonus time value (Val) for each of a plurality of bonus time values that can be granted, c) determining the number (Num) of bonus time values within the plurality of bonus time values, d) determining the minimum bonus time value (Min) within the plurality of bonus time values, e) setting the probability of granting a particular one of the plurality of bonus time values, not including the minimum bonus time value, equal to: (Avg−Min)/((Val−Min)*(Num−1)), and f) setting the probability of granting the minimum bonus time value of the plurality of bonus time values equal to one minus the sum of the probabilities of granting each of the other plurality of bonus time values. In the example of the prior paragraph, the probability of winning 45 seconds of bonus service time is: (20 sec−10 sec)/((45 sec−10 sec)*(8−1))=4.1%.

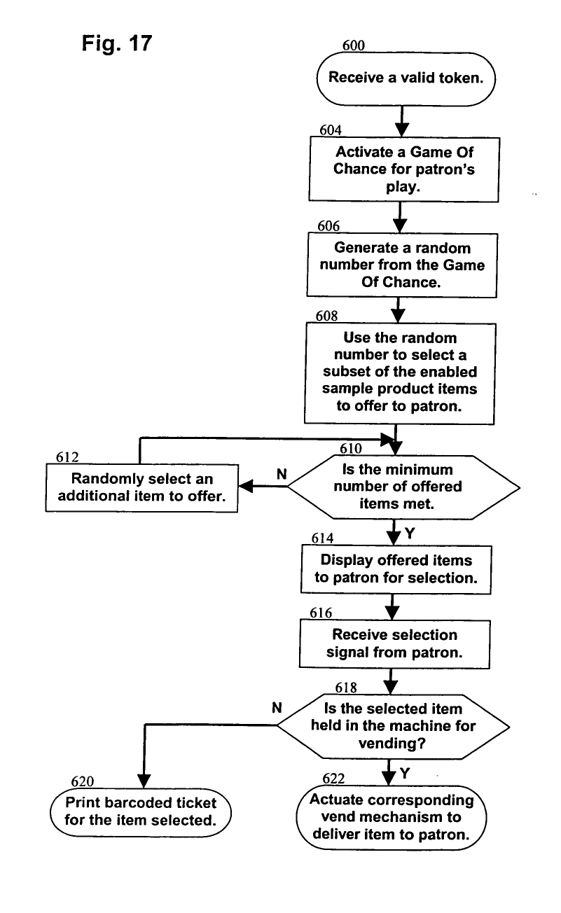

The flow chart of FIG. 17 summarizes the basic operation of product sample vending machine 300 through a game of chance cycle. It starts with step 600 when a valid product sample token is received. The game of chance is activated for patron's play in step 604. During the game of chance, a random number is generated in step 606 and used in step 608 with predetermined probabilities for winning each item to determine which items to offer to the patron. In steps 610 and 612, the number of items offered is increased according to a predetermined minimum number to give patron a choice in a manner that does not include increasing cost for the sponsor. The items from which the patron may select are then displayed to him for his selection in step 614. The patron then makes his selection from among those items offered and presses a button to send a corresponding signal indicating the selection in step 616. Finally, in steps 618, 620, and 622 the vending machine determines if the item can be immediately dispensed or if a barcoded ticket should printed as a voucher for the item selected.

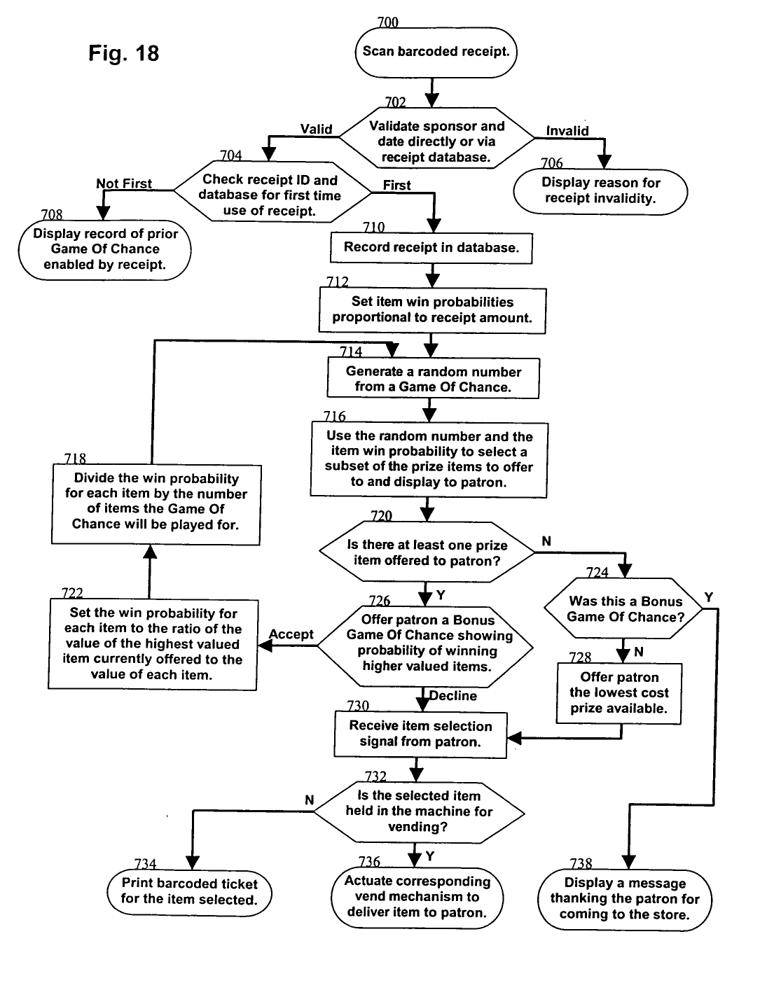

The flow chart of FIG. 18 summarizes the basic operation of customer appreciation vending machine 350 through a game of chance wherein it is a barcoded purchase receipt that is used to enable the game of chance. It starts with step 700 when a patron's barcoded purchase receipt is read by the machine's barcode reader. In step 702 the read data is validated directly if sufficient information about the purchase is present, or indirectly via a remote receipt database if a transaction ID is present on the purchase receipt. If the information on the purchase receipt is invalid for purposes of enabling the game of chance, the reasons are displayed to the patron in step 706. If the purchase receipt is valid, it is checked for first time use in step 704. If it is not the first time this receipt has been used to enable a game of chance, the record of the prior played game of chance is displayed in step 708. If this is the first use of this purchase receipt for this purpose, then its information is recorded in a database for future validation purposes in step 710 and item win probabilities are set in proportion to the purchase receipt amount in step 712. During the game of chance in step 714, a random number is generated to determine the outcome of the game of chance for use with the item win probabilities in step 716 to determine which subset of prize items to offer to and display to the patron. In steps 720 and 726 if there is at least one prize item that is offered, then the patron is also offered a bonus game of chance. If the patron accepts play of a bonus game of chance, the win probabilities for each of the items are set in proportion to the ratio of the value of the highest valued item currently offered to the value of each item in step 722, and divided by the number of items for which the game of chance will be played in step 718. The bonus game of chance then cycles back to the step 714 where a new random number is generated from the bonus game of chance for use in determining a revised subset of items to offer to the patron. If there is not at least one item offered to the patron following the game of chance and it was the initial game of chance, the patron is offered the lowest valued item in steps 724 and 728, but is not offered a bonus game of chance. The patron then selects from among the items being offered in step 730. Finally, in steps 732, 734, and 736 the vending machine determines if the item can be immediately dispensed or if a barcoded ticket should be printed as a voucher for the item selected.

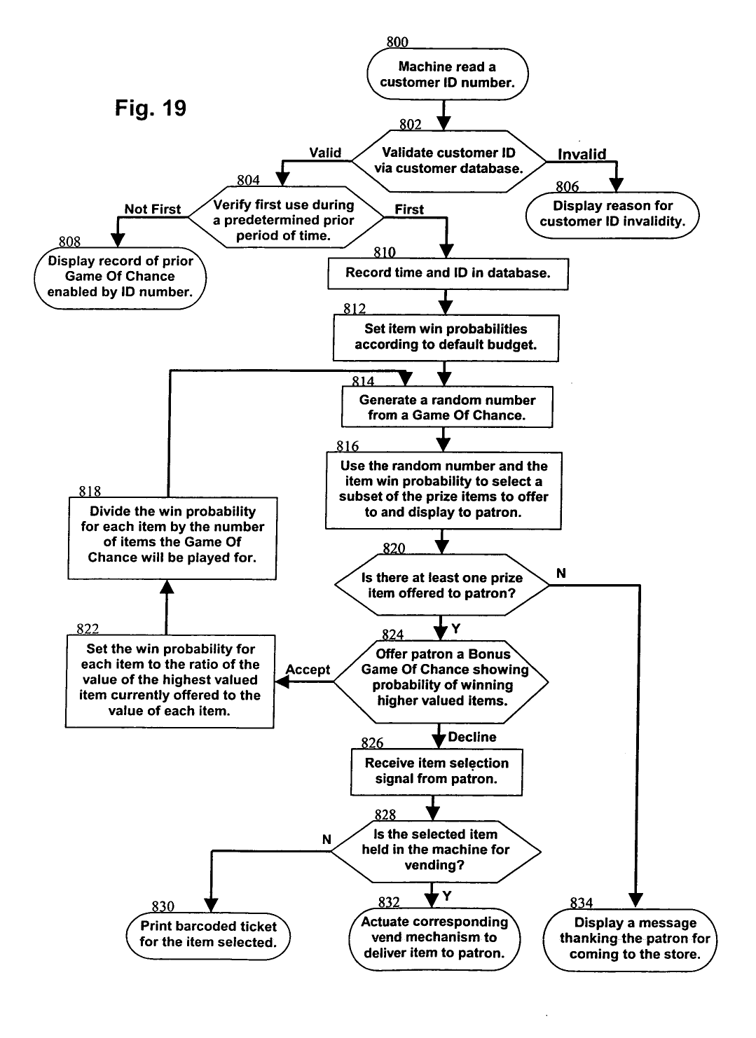

The flow chart of FIG. 19 summarizes the basic operation of customer appreciation vending machine 350 through a game of chance wherein it is a customer ID number that is used to enable the game of chance. It starts with step 800 when a patron's customer ID is read by the machine's barcode reader or RFID tag reader. In step 802 the read data is validated via a customer database. If the customer ID information is invalid for purposes of enabling the game of chance, the reasons are displayed to the patron in step 806. If the customer ID number is valid, it is checked for first time use during a predetermined prior period of time in step 804. If it is not the first time, the record of the prior played game of chance is displayed in step 808. If this is the first use during a predetermined prior period of time, then its information is recorded in a database for future validation purposes in step 810 and item win probabilities are set according to their allocated fractional share of a default total per-vend budget and inversely proportional to the value of each item in step 812. From this point, the steps correspond to those previously described for FIG. 18 with the exception that the minimum value item is not guaranteed to be offered to the patron when nothing has been won during any game of chance.

It is to be understood that the above described embodiments of the invention are illustrative only, and many variations and modifications will become apparent to one skilled in the art without departing from the spirit and scope of the present invention.

What is claimed is:

1. A vending machine for dispensing customer appreciation prizes to patrons comprising
storage and vend actuation means for multiple units of at least one low value prize item,
storage and vend actuation means for prize vouchers redeemable for at least one other prize item having at least 10 times higher value than the at least one low value prize item, but which cannot be dispensed by the machine,
means for reading information from a barcode on a patron's purchase receipt including means responsive to the read information to determine a patron's purchase amount, means responsive to the read information to validate a patron's purchase receipt for a single use only, and means responsive to the read information to validate a patron's purchase receipt only if a predetermined test utilizing at least one of a) location information, b) time information, and c) transaction ID number information is satisfied,
win probability setting means for predetermining the win probability of each prize item in response to a patron's purchase amount and to the cost or value of each prize items,
game of chance means enabled by validation of patron's receipt for producing a random outcome used in combination with the predetermined win probability for each prize item to determine which subset of prize items will be offered to the patron for selection,
display means for displaying the offered subset of prize items a patron may select from for vending, and
selection means used by a patron for selecting from the offered subset of prize items and for producing a vend control signal for the corresponding vend actuation means to deliver to the patron his selection.

2. The vending machine according to claim 1 further including communication means for transmitting a transaction ID number read from a patron's receipt and receiving purchase amount and time information in return from a remote database.

3. The vending machine according to claim 1 wherein the game of chance means further includes logic means for ensuring that the offered subset of prize items will always have at least one member if a patron's purchase amount exceeds a predetermined purchase threshold.

4. The vending machine according to claim 1 further including display means for conveying information to prospective patrons about the recent win record of at least one prize item.

5. The vending machine according to claim 1 further including prior use reporting means for displaying at least one of a) information about when the purchase receipt was previously used to enable a game of chance, b) information about the subset of prizes offered as a result of a prior game of chance enabled by the purchase receipt, and c) status information about any prize selected as a result of a prior game of chance enabled by the purchase receipt.

6. The vending machine according to claim 1 wherein the game of chance means includes logic means for testing the subset of prize items to be offered to the patron such that if the subset of offered prize items does not contain the lowest cost of all available prize items then at least one additional prize item of lower cost will be included in the subset of offered prize items.

7. The vending machine according to claim 1 including bonus game of chance means enabled when the subset of prizes offered to a patron for selection is not an empty subset including
bonus win probability setting means for predetermining the bonus win probability of a prize item wherein the bonus win probability for a prize item is at least in part based on a) the ratio of cost between the prize item and the cost of the highest valued prize item in the current subset of prize items offered to the patron and b) the number of prizes to be included in the bonus game of chance,
display means for displaying to a patron the probability of winning a prize of higher value than those currently offered for his selection,
play/decline selection means used by a patron for choosing to play or decline to play the bonus game of chance, and
bonus game win evaluation means for producing a random outcome used in combination with the predetermined bonus win probability for a prize item for determining which subset of prize items will be offered to the patron for selection.

8. A method of dispensing customer appreciation prizes from a vending machine comprising the steps of
providing a vending machine with a storage and vend actuation means for multiple units of at least one low value prize item and for redeemable prize vouchers for at least one other prize item having at least 10 times higher value than the at least one low value prize item, but which cannot be dispensed by the machine,
providing a barcoded purchase receipt to a patron including a) a transaction ID number for communication with a remote database to retrieve at least the purchase amount, or b) the purchase amount and at least one of the purchase location and the purchase time,
machine-validating the barcoded purchase receipt to enable a game of chance on the vending machine only once for each purchase receipt and only if a predetermined test utilizing at least one of a) location information, b) time information, and c) transaction ID number information is satisfied,
setting a predetermined win probability for each prize item responsive to a patron's purchase amount, and to the cost or value of each prize item,
executing a game of chance to produce a random outcome used in conjunction with the predetermined win probability for each prize item to determine which subset of prize items will be offered to the patron for selection,
displaying the offered subset of prize items a patron may select from for vending, and
dispensing the prize item or redeemable prize voucher corresponding to the selection made by the patron.

9. The method of dispensing customer appreciation prizes according to claim 8 wherein the step of setting the predetermined win probability for each prize item includes the steps of
setting a percentage of the purchase amount to be allocated to a budget for dispensing won items,
setting a mean total budget for dispensing an item equal to the percentage of the purchase amount allocated for dispensing won items multiplied by the patron's purchase amount,
setting an item's allocated fractional share of the mean total budget for dispensing an item such that the sum of all allocated fractional shares is unity,
setting a mean item budget for each item equal to the mean total budget for dispensing an item multiplied by the item's allocated fractional share of the mean total budget, and
setting the probability of winning an item equal to the mean item budget divided by the cost or value of the item.

10. The method of dispensing customer appreciation prizes according to claim 8 including the further step of ensuring that the offered subset will have at least one member if a patron's purchase amount exceeds a predetermined purchase threshold.

11. The method of dispensing customer appreciation prizes according to claim 8 including the further step of displaying information to prospective patrons indicating how many times in a preselected period of time other patrons have won at least one of the other prize items.

12. The method of dispensing customer appreciation prizes according to claim 8 including the further step of displaying at least one of a) information about when the purchase receipt was previously used to enable a game of chance, b) information about the subset of prizes offered as a result of a prior game of chance enabled by the purchase receipt, and c) status information about any prize selected as a result of a prior game of chance enabled by the purchase receipt.

13. The method of dispensing customer appreciation prizes according to claim 8 including the further step of including at least a second prize item of lower cost in the subset of offered prize items if the current subset of offered prize items does not contain the lowest cost of all available prize items.

14. The method of dispensing customer appreciation prizes according to claim 8 including the further steps of
enabling a bonus game of chance when the subset of prizes offered to a patron for selection is not an empty subset,
setting a predetermined bonus win probability for each prize based at least in part on a) the ratio of cost between the prize item and the cost of the highest valued prize item in the current subset of prize items offered to the patron and b) the number of other prizes to be included in the bonus game of chance,
displaying to a patron the probability of winning a prize of higher value than those currently offered for his selection, and
receiving a play/decline selection signal from the patron to conditionally execute the bonus game of chance to produce a random outcome used in conjunction with the predetermined bonus win probability for each prize item to determine which subset of prize items will be offered to the patron for selection.

15. A vending machine for dispensing customer appreciation prizes to patrons comprising
storage and vend actuation means for multiple units of at least one low value prize item,
storage and vend actuation means for prize vouchers redeemable for at least one other prize item having at least 10 times higher value than the at least one low value prize item, but which cannot be dispensed by the machine,
token validation means for authenticating a free token provided to a patron by a proprietor at the point of sale, the token validation means being constructed and arranged for authenticating metal or plastic coin shaped tokens having at least one distinguishable security feature identifiable with the proprietor,
win probability setting means for predetermining the win probability of each prize item in response to the cost or value of each prize item and to a predetermined mean budget for dispensing an item,
game of chance means enabled by validation of at least one free token for producing a random outcome used in combination with the predetermined win probability for each prize item to determine which subset of prize items will be offered to the patron for selection,
display means for displaying the offered subset of prize items a patron may select from for vending, and
selection means used by a patron for selecting from the offered subset of prize items and for producing a vend control signal for the corresponding vend actuation means to deliver to the patron his selection.

16. The vending machine according to claim 15 wherein the game of chance means further includes logic means for ensuring that the offered subset of prize items will always have at least one member.

17. The vending machine according to claim 15 further including a display means for conveying information to prospective patrons about the recent win record of at least one prize item.

18. The vending machine according to claim 15 wherein the game of chance means includes logic means to test the subset of prize items to be offered to the patron such that if the subset of offered prize items does not contain the lowest cost of all available prize items then at least one additional prize item of lower cost will be included in the subset of offered prize items.

19. The vending machine according to claim 15 including bonus game of chance means enabled when the subset of prizes offered to a patron for selection is not an empty subset including
bonus win probability setting means for predetermining the bonus win probability of a prize item, wherein the bonus win probability for a prize item is at least in part based on a) the ratio of cost between the prize item and the cost of the highest valued prize item in the current subset of prize items offered to the patron and b) the number of prizes to be included in the bonus game of chance,
display means for displaying to a patron the probability of winning a prize of higher value than those currently offered for selection,
play/decline selection means used by a patron for choosing to play or decline to play the bonus game of chance, and
bonus game win evaluation means for producing a random outcome used in combination with the predetermined bonus win probability for a prize item to determine which subset of prize items will be offered to the patron for selection.

20. A method of dispensing customer appreciation prizes from a vending machine comprising the steps of
providing a vending machine with a storage and vend actuation means for multiple units of at least one low value prize item and for redeemable prize vouchers for at least one other prize item having at least 10 times higher value than the at least one low value prize item, but which cannot be dispensed by the machine,
providing a free token to a patron by a proprietor at the point of sale wherein the free token is at least one of metal and plastic, coin shaped, and has at least one distinguishable security feature identifiable with the proprietor,
machine-validating a patron's free token to enable a game of chance on the vending machine only once for each free token and only if the token has the at least one distinguishable security feature identifiable with the proprietor,
setting a predetermined win probability for each prize item responsive to the cost or value of each prize item and to a predetermined mean budget for dispensing an item,
executing a game of chance to produce a random outcome used in conjunction with the predetermined win probability for each prize item to determine which subset of prize items will be offered to the patron,
displaying the offered subset to the patron for selection, and
dispensing the prize item or redeemable prize voucher corresponding to the selection made by the patron.

21. The method of dispensing customer appreciation prizes according to claim 20 wherein the step of setting the predetermined win probability for each prize item includes the steps of
setting a mean budget for dispensing an item,
setting an item's allocated fractional share of the mean budget for dispensing an item such that the sum of all allocated fractional shares is unity,
setting a mean item budget for each item equal to the mean budget for dispensing an item multiplied by the item's allocated fractional share of the mean budget, and
setting the probability of winning an item equal to the mean item budget divided by the cost or value of the item.

22. The method of dispensing customer appreciation prizes according to claim 20 including the further step of ensuring that the offered subset has at least one member.

23. The method of dispensing customer appreciation prizes according to claim 20 including the further step of displaying information to prospective patrons indicating how many times in a preselected period of time other patrons have won at least one of the other prize items.

24. The method of dispensing customer appreciation prizes according to claim 20 including the further step of including at least a second prize item of lower cost in the subset of offered prize items if the current subset of offered prize items does not contain the lowest cost of all available prize items.

25. The method of dispensing customer appreciation prizes according to claim 20 including the further steps of
enabling a bonus game of chance when the subset of prizes offered to a patron for selection is not an empty subset,
setting a predetermined bonus win probability for each prize based at least in part on a) the ratio of cost between the prize item and the cost of the highest valued prize item in the current subset of prize items offered to the patron and b) the number of other prizes to be included in the bonus game of chance,
displaying to a patron the probability of winning a prize of higher value than those currently offered for selection, and
receiving a play/decline selection signal from a patron to conditionally execute the bonus game of chance to produce a random outcome used in conjunction with the predetermined bonus win probability for each prize item to determine which subset of prize items will be offered to the patron for selection.

26. A vending machine for dispensing customer appreciation prizes to patrons comprising
storage and vend actuation means for multiple units of at least one low value prize item and for prize vouchers redeemable for at least one other prize item having at least 10 times higher value than the at least one low value prize item, but which cannot be dispensed by the machine,
customer ID validation means for machine reading a patron's customer ID number from a customer ID carrier, the customer ID validation means including means for validating a patron's customer ID only if the patron is a registered customer of the proprietor and only once during a predetermined period of time,
win probability setting means for predetermining the win probability of each prize item in response to the cost or value of each prize item and to a predetermined mean budget for dispensing an item,
game of chance means enabled by validation of a patron's customer ID number for producing a random outcome used in combination with the predetermined win probability for each prize item to determine which subset of prize items will be offered to the patron for selection,
display means for displaying the offered subset of prize items a patron may select from for vending, and
selection means used by a patron for selecting from the offered subset of prize items and for producing a vend control signal for the corresponding vend actuation means to deliver to the patron his selection.

27. The vending machine according to claim 26 including communication means for transmitting a customer ID number read from patron's customer ID carrier and receiving ID registration status information in return from a remote database.

28. The vending machine according to claim 26 wherein the game of chance means further includes logic means for ensuring that the offered subset of prize items will always have at least one member.

29. The vending machine according to claim 26 further including display means for conveying information to prospective patrons about the recent win record of at least one prize item.

30. The vending machine according to claim 26 further including prior use reporting means for conveying on the display means at least one of a) information about when the customer ID was previously used to enable a game of chance, b) information about the subset of prizes offered as a result of a prior game of chance enabled by the customer ID, and c) status information about any prize selected as a result of a prior game of chance enabled by the customer ID.

31. The vending machine according to claim 26 wherein the game of chance means includes logic means to test the subset of prize items to be offered to the patron such that if the subset of offered prize items does not contain the lowest cost of all available prize items then at least one additional prize item of lower cost will be included in the subset of offered prize items.

32. The vending machine according to claim 26 further including
bonus game of chance means enabled when the subset of prizes offered to a patron for selection is not an empty subset,
bonus win probability setting means for predetermining the bonus win probability of a prize item, wherein the bonus win probability for a prize item is at least in part based on a) the ratio of cost between the prize item and the cost of the highest valued prize item in the current subset of prize items offered to the patron and b) the number of prizes to be included in the bonus game of chance,
display means for displaying to a patron the probability of winning a prize of higher value than those currently offered for selection,
play/decline selection means used by a patron for choosing to play or decline to play the bonus game of chance, and
bonus game win evaluation means for producing a random outcome used in combination with the predetermined bonus win probability for a prize item to determine which subset of prize items will be offered to the patron for selection.

33. A method of dispensing customer appreciation prizes from a vending machine comprising the steps of
providing a vending machine with a storage and vend actuation means for multiple units of at least one low value prize item and for redeemable prize vouchers for at least one other prize item having at least 10 times higher value than the at least one low value prize item, but which cannot be dispensed by the machine,
providing a customer ID carrier to a patron from a proprietor with the customer ID carrier having a machine-readable customer ID number registered with the proprietor,
machine-validating a customer ID number to enable a game of chance on the vending machine only once during a predetermined period of time,
setting a predetermined win probability for each prize item responsive to the cost or value of each prize item and to a predetermined mean budget for dispensing an item,
executing a game of chance to produce a random outcome used in conjunction with the predetermined win probability for each prize item to determine which subset of prize items will be offered to the patron for selection,
displaying the offered subset to the patron for selection, and
dispensing the prize item or redeemable prize voucher corresponding to the selection made by the patron.

34. The method of dispensing customer appreciation prizes according to claim 33 wherein the step of setting the predetermined win probability for each prize item includes the steps of
setting a mean budget for dispensing an item,
setting an item's allocated fractional share of the mean budget for dispensing an item such that the sum of all allocated fractional shares is unity,
setting a mean item budget for each item equal to the mean budget for dispensing an item multiplied by the item's allocated fractional share of the mean budget, and
setting the probability of winning an item equal to the mean item budget divided by the cost or value of the item.

35. The method of dispensing customer appreciation prizes according to claim 33 including the further step of ensuring that the offered subset will have at least one member.

36. The method of dispensing customer appreciation prizes according to claim 33 including the further step of displaying information to prospective patrons indicating how many times in a preselected period of time other patrons have won at least one of the other prize items.

37. The method of dispensing customer appreciation prizes according to claim 33 including the further step of including at least a second prize item of lower cost in the subset of offered prize items if the current subset of offered prize items does not contain the lowest cost of all available prize items.

38. The method of dispensing customer appreciation prizes according to claim 33 including the further steps of
enabling a bonus game of chance when the subset of prizes offered to a patron for selection is not an empty subset,
setting a predetermined bonus win probability for each prize based at least in part on a) the ratio of cost between the prize item and the cost of the highest valued prize item in the current subset of prize items offered to the patron and b) the number of other prizes to be included in the bonus game of chance,
displaying to a patron the probability of winning a prize of higher value than those currently offered for his selection, and
receiving a play/decline selection signal from the patron to conditionally execute the bonus game of chance to produce a random outcome used in conjunction with the predetermined bonus win probability for each prize item to determine which subset of prize items will be offered to the patron for selection.
